(19) United States
(12) Patent Application Publication
(10) Pub. No.: US 2026/0151000 A1
(43) Pub. Date: Jun. 4, 2026

(54) VENTED DRIP TRAYS FOR GRILLS

(71) Applicant: Weber-Stephen Products LLC, Palatine, IL (US)

(72) Inventors: Eric G. Griswold, Cary, IL (US); Marshall Tatro, Palatine, IL (US)

(21) Appl. No.: 19/216,704

(22) Filed: May 22, 2025

Related U.S. Application Data
(63) Continuation of application No. 19/009,054, filed on Jan. 3, 2025.
(60) Provisional application No. 63/726,695, filed on Dec. 2, 2024.

(51) Int. Cl. A47J 37/07

(52) U.S. Cl. CPC A47J 37/0786; A47J 37/0704

(57) ABSTRACT

Grills including waste collection assemblies incorporating drip trays are disclosed. A cookbox of a grill includes a bottom wall and an opening extending through the bottom wall. A cooking grate is positioned within the cookbox. A heat source is positioned within the cookbox below the cooking grate. A drip tray is positioned within the cookbox below the cooking grate and above the heat source. The drip tray includes a base, a border, and a drain. The drain includes an opening extending through the base. A waste bin is slidably coupled to the cookbox and positioned below the opening of the bottom wall. A waste chute is positioned within the cookbox. The waste chute is configured to receive waste from the opening of the drain of the drip tray and direct the received waste to pass through the opening of the bottom wall of the cookbox into the waste bin.

### RELATED APPLICATIONS

This application is a continuation of U.S. patent application Ser. No. 19/009,054, filed Jan. 3, 2025, which claims priority to U.S. Provisional Patent Application No. 63/726,695, filed Dec. 2, 2024. The entireties of U.S. patent application Ser. No. 19/009,054 and U.S. Provisional Patent Application No. 63/726,695 are hereby incorporated by reference herein.

### FIELD OF THE DISCLOSURE

This disclosure relates generally to drip trays for grills and, more specifically, to vented drip trays for grills.

### BACKGROUND

Grills (e.g., pellet grills, gas grills, charcoal grills, electric grills, etc.) are commonly equipped with a cookbox configured to warm, heat, and/or cook one or more food item(s). In some known implementations, the grill further includes one or more heat source(s) and one or more cooking grate(s) disposed within the cookbox, with the heat source(s) positioned below the cooking grate(s). For example, pellet grills typically include a burn pot and one or more cooking grate(s) disposed within a cookbox of the pellet grill, with the burn pot positioned below the cooking grate(s). As another example, gas grills typically include one or more gas burner(s) (e.g., gas burner tube(s)) and one or more cooking grate(s) disposed within a cookbox of the gas grill, with the gas burner(s)positioned below the cooking grate(s). In such implementations, the heat source(s) is/are configured to generate heat that subsequently warms, heats, and/or cooks one or more item(s) of food disposed on the cooking grate(s).

Regardless of the type of grill and/or the type of heat source, it is a common occurrence for the cooking process and/or the item(s) of food associated therewith to produce grease. In view of the flammability of grease, it is typically desirable to prevent grease that is produced during the cooking process from dripping and/or otherwise passing downwardly from the cooking grate(s) onto and/or into the heat source(s). It is accordingly common for one or more grease deflection device(s) (e.g., a drip tray, one or more grease deflection bar(s), etc.) to be disposed within the cookbox of the grill at a position that is below the cooking grate(s) and above the heat source(s). For example, pellet grills typically include a drip tray disposed within a cookbox of the pellet grill, with the drip tray positioned below the cooking grate(s) and above the burn pot.

Conventionally, drip trays for grills are configured with a sloped surface that causes grease received on the drip tray to be directed (e.g., via gravity) toward a particular edge (e.g., a right edge, a left edge, a front edge, or a rear edge) of the drip tray. Once the grease reaches the particular edge of the drip tray, it is then typically directed either downwardly within the cookbox toward a waste collection device positioned below the cookbox, or outwardly from the cookbox into a waste collection device positioned at the side of the cookbox. As the purpose of the drip tray is to prevent grease from dripping onto and/or into the heat source(s) of the grill, drip trays are typically configured as a continuous sheet of material that lacks any openings and/or vents extending therethrough.

### BRIEF DESCRIPTION OF THE DRAWINGS

FIG. 1 is a first perspective view of an example drip tray constructed in accordance with the teachings of this disclosure.

FIG. 2 is a second perspective view of the drip tray of FIG. 1.

FIG. 3 is a top view of the drip tray of FIGS. 1 and 2.

FIG. 4 is a bottom view of the drip tray of FIGS. 1-3.

FIG. 5 is a front view of the drip tray of FIGS. 1-4.

FIG. 6 is a rear view of the drip tray of FIGS. 1-5.

FIG. 7 is a right side view of the drip tray of FIGS. 1-6.

FIG. 8 is a left side view of the drip tray of FIGS. 1-7.

FIG. 9 is a cross-sectional view of the drip tray of FIGS. 1-8 taken along section A-A of FIG. 3.

FIG. 10 is a cross-sectional view of the drip tray of FIGS. 1-9 taken along section B-B of FIG. 3.

FIG. 11 is a first perspective view of an example vent shield constructed in accordance with the teachings of this disclosure.

FIG. 12 is a second perspective view of the vent shield of FIG. 11.

FIG. 13 is a first perspective view of an example drip tray assembly constructed in accordance with the teachings of this disclosure.

FIG. 14 is a second perspective view of the drip tray assembly of FIG. 13.

FIG. 15 is a top view of the drip tray assembly of FIGS. 13 and 14.

FIG. 16 is a bottom view of the drip tray assembly of FIGS. 13-15.

FIG. 17 is a front view of the drip tray assembly of FIGS. 13-16.

FIG. 18 is a rear view of the drip tray assembly of FIGS. 13-17.

FIG. 19 is a right side view of the drip tray assembly of FIGS. 13-18.

FIG. 20 is a left side view of the drip tray assembly of FIGS. 13-19.

FIG. 21 is a cross-sectional view of the drip tray assembly of FIGS. 13-20 taken along section C-C of FIG. 15.

FIG. 22 is a cross-sectional view of the drip tray assembly of FIGS. 13-21 taken along section D-D of FIG. 15.

FIG. 23 is a perspective view of an example grill including the drip tray assembly of FIGS. 13-22.

FIG. 24 is a perspective view of the grill of FIG. 23, shown with the cooking grates of the grill removed to better illustrate the drip tray assembly.

FIG. 25 is a top view of the grill of FIGS. 23 and 24, shown with the cooking grates and the lid of the grill removed to better illustrate the drip tray assembly.

FIG. 26 is a cross-sectional view of the grill of FIGS. 23-25 taken along section E-E of FIG. 25.

FIG. 27 is an enlarged view of a portion of FIG. 26.

FIG. 28 is an enlarged view of a portion of FIG. 25.

FIG. 29 is a first perspective view of another example drip tray constructed in accordance with the teachings of this disclosure.

FIG. 30 is a second perspective view of the drip tray of FIG. 29.

FIG. 31 is a first perspective view of another example drip tray assembly constructed in accordance with the teachings of this disclosure.

FIG. 32 is a second perspective view of the drip tray assembly of FIG. 31.

FIG. 33 corresponds to the grill of FIGS. 23-28 as shown in FIG. 28, but including the drip tray assembly of FIGS. 31 and 32 in lieu of the drip tray assembly of FIGS. 13-22.

FIG. 34 is a first perspective view of an example heat shield constructed in accordance with the teachings of this disclosure.

FIG. 35 is a second perspective view of the heat shield of FIG. 34.

FIG. 36 is an exploded view illustrating the heat shield of FIGS. 34 and 35 relative to the drip tray of FIGS. 29 and 30.

FIG. 37 is a top view of the heat shield of FIGS. 34-36 coupled to the drip tray of FIGS. 29, 30, and 36.

FIG. 38 is a front view of the heat shield of FIGS. 34-37 coupled to the drip tray of FIGS. 29, 30, 36, and 37.

FIG. 39 is a cross-sectional view of the heat shield of FIGS. 34-38 coupled to the drip tray of FIGS. 29, 30, and 36-38, taken along section F-F of FIG. 37.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, drip trays that are intended to be disposed within a cookbox of a grill at a position between the heat source(s) and the cooking grate(s) of the grill are typically configured with a sloped surface that causes grease received on the drip tray to be directed (e.g., via gravity) toward a particular edge (e.g., a right edge, a left edge, a front edge, or a rear edge) of the drip tray. Once the grease reaches the particular edge of the drip tray, it is then typically directed either downwardly within the cookbox of the grill toward a waste collection device positioned below the cookbox, or outwardly from the cookbox of the grill into a waste collection device positioned at the side of the cookbox. As the primary purpose of implementing a drip tray is to prevent grease from dripping downwardly from the cooking grate(s) of the grill onto and/or into the heat source(s) of the grill, drip trays are typically configured as a continuous sheet of material that lacks any openings and/or vents extending therethrough. One disadvantage of such an arrangement is that the solid surface barrier created by the drip tray restricts and/or obstructs heated air that is generated by the heat source(s) of the grill from traveling upwardly to the cooking grate(s) of the grill. Such heated air must instead travel around the perimeter of the drip tray before the traveling upwardly to the cooking grate(s). Depending on the layout and/or the footprint of the drip tray relative to that of the cookbox of the grill, the drip tray can accordingly cause the distribution of heated air at the cooking grate(s) to be biased and/or unbalanced toward a particular side and/or a particular area of the cooking grate(s), which can negatively impact the cooking process.

Unlike the known drip trays described above, example drip trays disclosed herein include one or more vent(s) extending through the drip tray, with the vent(s) being configured to advantageously enable heated air to pass directly through one or more portion(s) of the drip tray (e.g., from a location below the drip tray to a location above the drip tray). For grills implementing such a disclosed drip tray, the presence of such vent(s) advantageously facilitates a more even and/or more balanced distribution of heated air at the cooking grate(s) of the grill relative to that which is otherwise demonstrated when implementing a conventional drip tray. The aforementioned benefit provided by of the vent(s) of the disclosed drip trays is achieved while retaining the ability to prevent grease from dripping downwardly (e.g., from a cooking grate) through the drip tray (e.g., through such vent(s)) and onto and/or into a heat source of a grill implementing such a disclosed drip tray.

In some disclosed examples, a drip tray for a grill includes a base and a border. The base includes an upper surface, a lower surface, a front edge, a rear edge, a right edge, and a left edge. The border projects upwardly from the upper surface of the base along the front edge, the rear edge, the right edge, and the left edge of the base. The border includes an inner wall, an outer wall, and a plurality of peripheral vents. Respective ones of the peripheral vents are formed in and extend through the inner wall.

In some disclosed examples, the respective ones of the peripheral vents are formed in and extend through the inner wall along two or more, and preferably along all four of a front portion, a rear portion, a right portion, and a left portion of the border. Respective ones of the front portion, the rear portion, the right portion, and the left portion of the border are adjacent corresponding respective ones of the front edge, the rear edge, the right edge, and the left edge of the base. In some disclosed examples, the inner wall of the border projects upwardly from the upper surface of the base, and the outer wall of the border projects downwardly from the inner wall of the border. In some disclosed examples, border has an inverted V-shaped cross-sectional profile formed by the inner wall and the outer wall. In some disclosed examples, the border forms an upper rim of the drip tray. In some disclosed examples, the border further includes a plurality of positioning notches formed in the outer wall of the border along two or more of a front portion, a rear portion, a right portion, and a left portion of the border. The aforementioned configuration of the border (e.g., including the peripheral vents formed therein) provides numerous benefits, including (1) minimizing the gap distance existing between the outer wall of the border of the drip tray and an interior surface of a sidewall of a cookbox within which the drip tray may be positioned, and (2) evenly distributing heated air produced by one or more heat source(s) located below the drip tray as such heated air migrates upwardly through the peripheral vents of the drip tray to one or more cooking grate(s) located above the drip tray.

In some disclosed examples, the border of the drip tray includes (e.g., in lieu of the positioning notches) a plurality of mounting supports extending outwardly from the outer wall of the border along two or more of a front portion, a rear portion, a right portion, and a left portion of the border. Although this configuration of the border does not minimize the gap distance existing between the outer wall of the border of the drip tray and an interior surface of a sidewall of a cookbox within which the drip tray may be positioned, the aforementioned configuration is nonetheless beneficial with regard to evenly distributing heated air produced by one or more heat source(s) located below the drip tray as such heated air migrates upwardly through the peripheral vents of the drip tray to one or more cooking grate(s) located above the drip tray.

In some disclosed examples, the drip tray further includes one or more central vent(s) formed in the base. Each central vent includes a lip projecting upwardly from the upper surface of the base. Each central vent further includes an opening extending through the upper surface and the lower surface of the base. For each central vent, the opening of the central vent is defined in part by the lip of the central vent.

In some disclosed examples, the lip of each central vent includes one or more positioning notches formed in the lip, with respective ones of the one or more positioning notches being configured to receive a mounting bracket of a vent shield when the vent shield is mounted on the lip of the central vent with the mounting bracket positioned in the one or more positioning notches. In some disclosed examples, each vent shield has an inverted V-shaped cross-sectional profile, with each vent shield being configured to cover the opening of the corresponding central vent when the vent shield is mounted on the lip of the corresponding central vent (e.g., with the mounting bracket positioned in the one or more positioning notches). In some disclosed examples, the inverted V-shaped cross-sectional profile of each vent shield includes lower edges that extend downwardly toward and/or about a periphery of the upper edge of the lip of the central vent on which the vent shield is mounted.

In some disclosed examples, each central vent includes a first cover segment located at and spanning across an upper edge of the lip, a second cover segment located at and spanning across the upper edge of the lip, and a positioning gap located at the upper edge of the lip between the first cover segment and the second cover segment, with the positioning gap being configured to receive a mounting bracket of a vent shield when the vent shield is mounted on the lip of the central vent with the mounting bracket positioned in the positioning gap. In some disclosed examples, each vent shield has an inverted V-shaped cross-sectional profile, with each vent shield being configured to cover at least a portion of the first cover segment and at least a portion of the second cover segment of the corresponding central vent when the vent shield is mounted on the lip of the corresponding central vent (e.g., with the mounting bracket positioned in the positioning gap). In some disclosed examples, the inverted V-shaped cross-sectional profile of each vent shield includes lower edges that extend downwardly toward and/or about a periphery of the upper edge of the lip of the central vent on which the vent shield is mounted.

Furthermore, each vent shield is configured to be removably mountable on a corresponding central vent such that the vent shield can advantageously be removed for cleaning. The aforementioned configuration of the central vent(s) (e.g., including the vent shield(s) mounted thereon) provides numerous benefits, including (1) directing heated air produced by one or more heat source(s) located below the drip tray to migrate upwardly through the central vent(s) of the drip tray to one or more cooking grate(s) located above the drip tray, (2) preventing undesirable combustion byproducts (e.g., ash) produced by one or more heat source(s) located below the drip tray from migrating upwardly through the central vent(s) of the drip tray to one or more cooking grate(s) located above the drip tray, and (3) preventing grease that drips from one or more cooking grate(s) downwardly onto the drip tray from passing downwardly through the central vent(s) of the drip tray onto and/or into one or more heat source(s) located below the drip tray.

In some disclosed examples, the drip tray further includes a drain formed in the base. The drain includes a lip projecting downwardly from the lower surface of the base. The drain further includes an opening extending through the upper surface and the lower surface of the base. The opening of the drain is defined in part by the lip of the drain. In some disclosed examples, the upper surface of the base includes a first portion and a second portion. The first portion is located between the right edge and the drain. The first portion slopes downwardly from the right edge toward the drain. The second portion is located between the left edge and the drain. The second portion slopes downwardly from the left edge toward the drain. In some disclosed examples, the upper surface of the base further includes a first channel and a second channel. The first channel is located between the first portion and the second portion and further located between the front edge and the drain. The first channel slopes downwardly from the front edge toward the drain. The second channel is located between the first portion and the second portion and further located between the rear edge and the drain. The second channel slopes downwardly from the rear edge toward the drain. The aforementioned configuration of the drain provides numerous benefits, including reducing the distance that grease which drips onto the drip tray must subsequently travel before such grease exits the drip tray, and/or before such grease exits a cookbox of a grill within which the drip tray may be positioned.

The above-identified features as well as other advantageous features of example vented drip trays for grills as disclosed herein are further described below in connection with the figures of the application.

As used herein, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

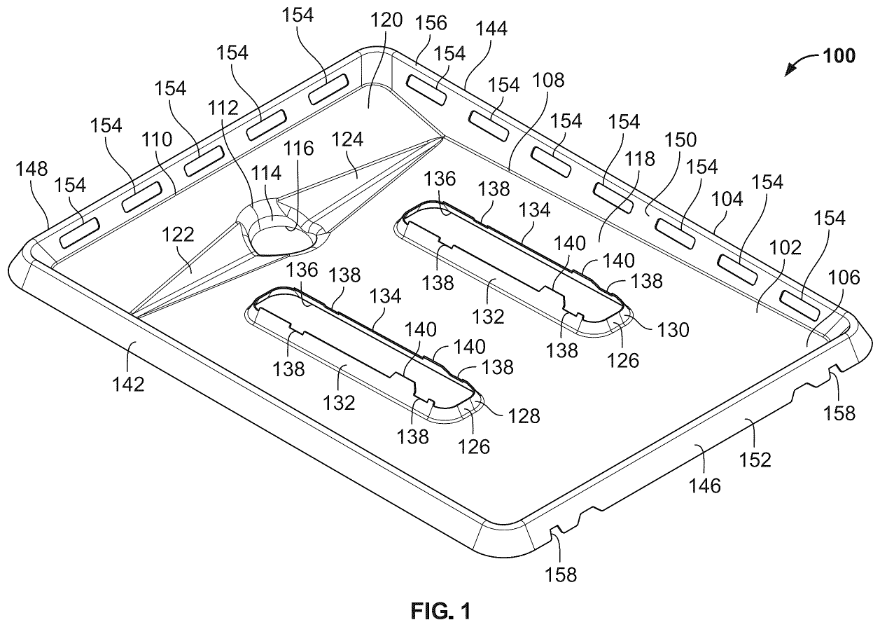

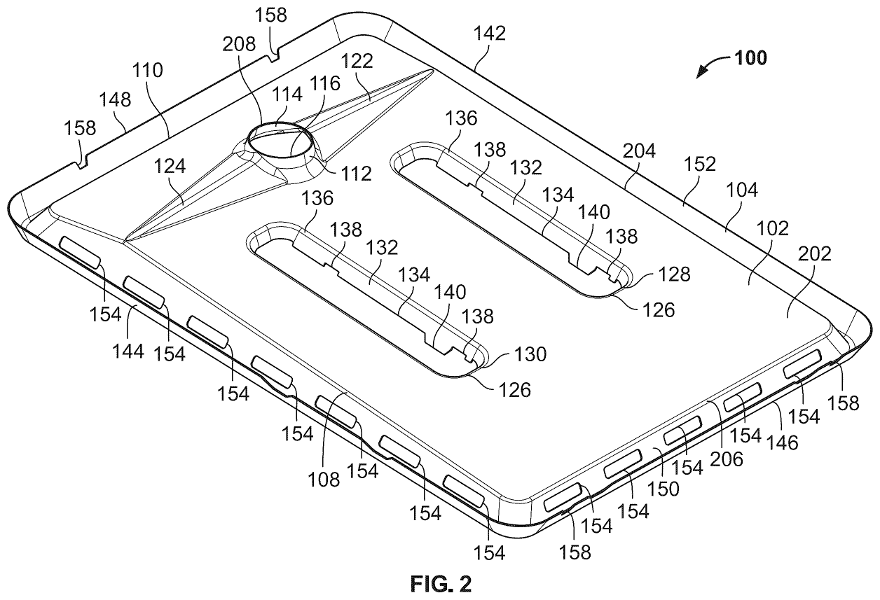

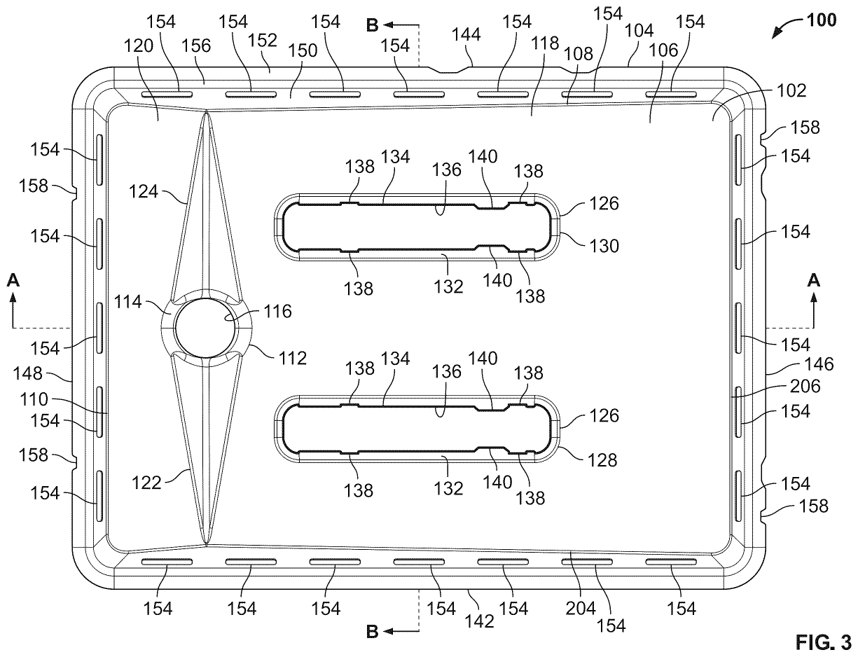

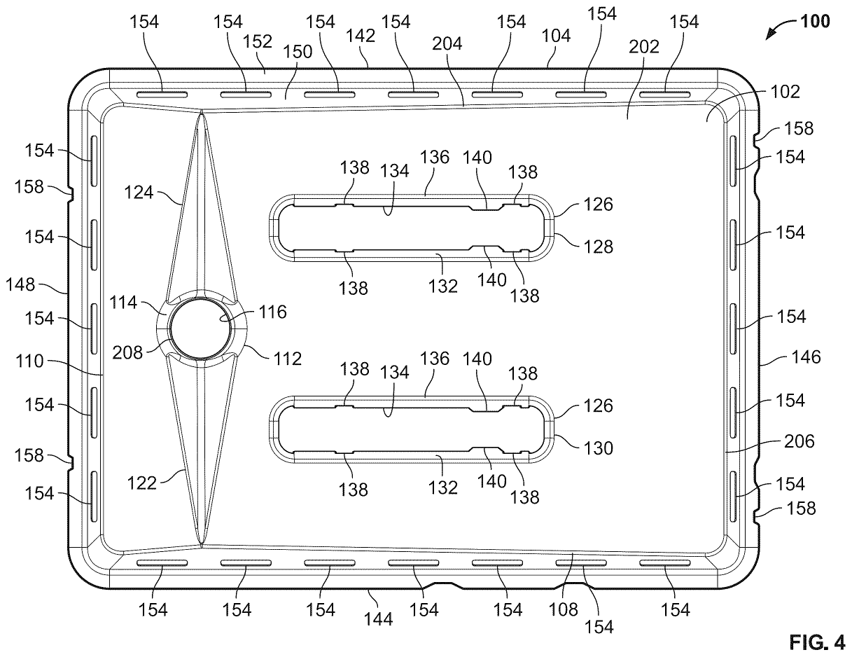

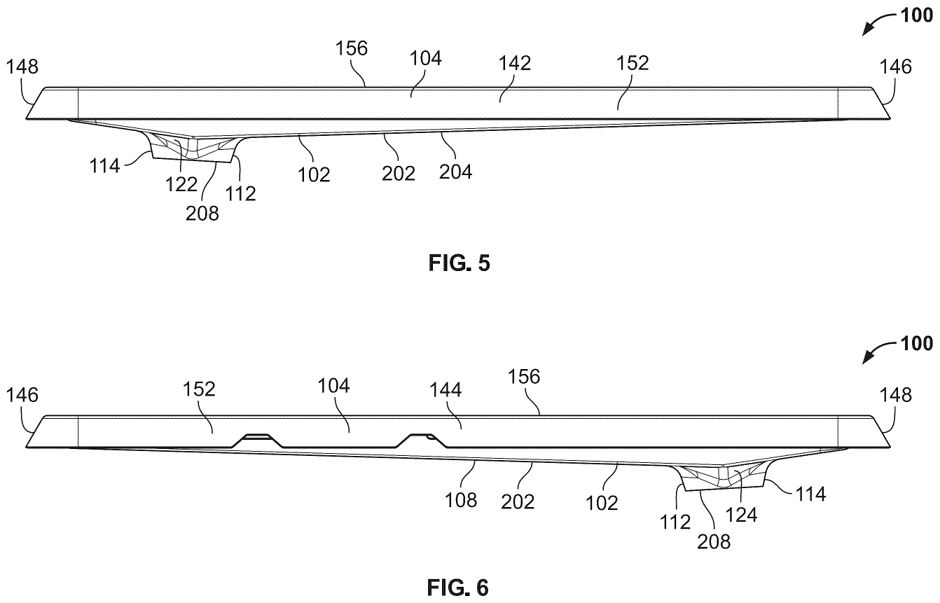

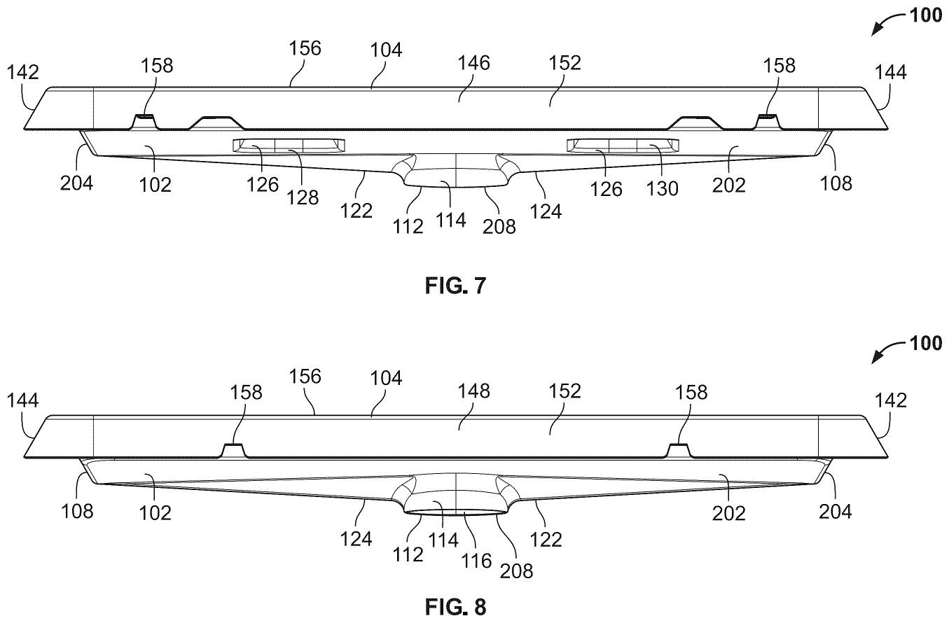

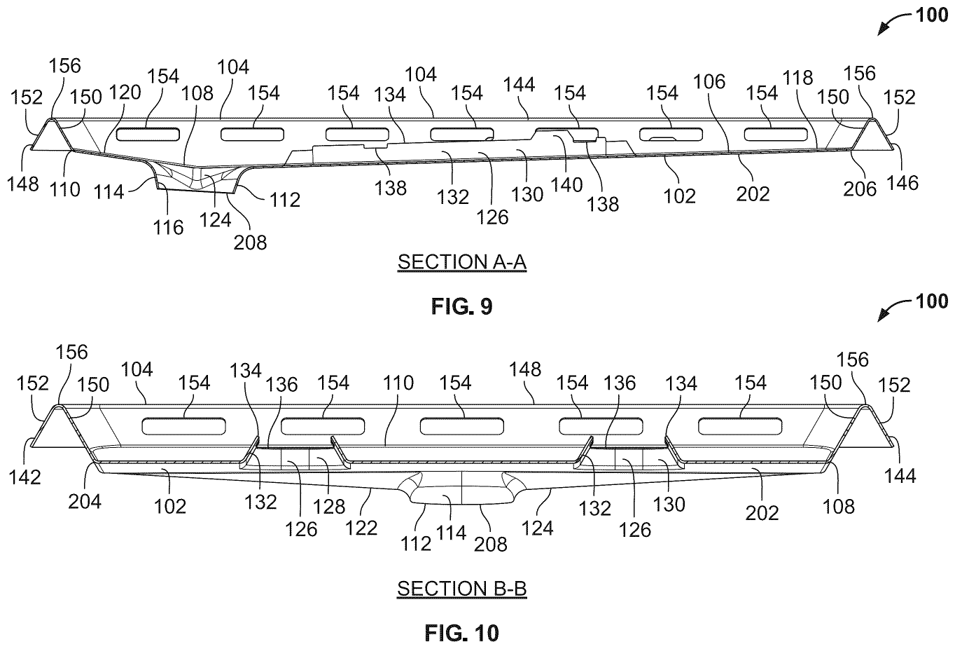

FIG. 1 is a first perspective view of an example drip tray 100 constructed in accordance with the teachings of this disclosure. FIG. 2 is a second perspective view of the drip tray of FIG. 1. FIG. 3 is a top view of the drip tray of FIGS. 1 and 2. FIG. 4 is a bottom view of the drip tray of FIGS. 1-3. FIG. 5 is a front view of the drip tray of FIGS. 1-4. FIG. 6 is a rear view of the drip tray of FIGS. 1-5. FIG. 7 is a right side view of the drip tray of FIGS. 1-6. FIG. 8 is a left side view of the drip tray of FIGS. 1-7. FIG. 9 is a cross-sectional view of the drip tray of FIGS. 1-8 taken along section A-A of FIG. 3. FIG. 10 is a cross-sectional view of the drip tray of FIGS. 1-9 taken along section B-B of FIG. 3.

The drip tray 100 of FIGS. 1-10 includes an example base 102 and an example border 104. The border 104 of the drip tray 100 circumscribes and/or otherwise surrounds a periphery of the base 102 of the drip tray 100. In the illustrated example of FIGS. 1-10, the border 104 is integrally formed with the base 102 such that the base 102 and the border 104 constitute a single, continuous piece of material that is free of joints, seams, and/or welds. In other examples, the border 104 can instead be coupled to the base 102 in a manner that results in one or more joint(s), seam(s), and/or weld(s) being formed between the border 104 and the base 102. In the illustrated example of FIGS. 1-10, the drip tray 100 (e.g., including the base 102 and the border 104 thereof) has a generally rectangular profile when viewed from the top side (e.g., as shown in FIG. 3) or the bottom side (e.g., as shown in FIG. 4) thereof. In other examples, the drip tray 100 can instead have a different geometric-shaped profile (e.g., triangular, squared, trapezoidal, hexagonal, octagonal, circular, elliptical, etc.) when viewed from the top side or the bottom side thereof.

The base 102 of the drip tray 100 of FIGS. 1-10 includes an example upper surface 106, an example lower surface 202, an example front edge 204, an example rear edge 108, an example right edge 206, and an example left edge 110. The lower surface 202 of the base 102 is located opposite the upper surface 106 of the base 102. The rear edge 108 of the base 102 is spaced apart from and located opposite the front edge 204 of the base 102. The right edge 206 and the left edge 110 of the base 102 respectively extend between the front edge 204 and the rear edge 108 of the base 102, with the left edge 110 of the base 102 being spaced apart from and located opposite the right edge 206 of the base 102. The front edge 204, the rear edge 108, the right edge 206, and the left edge 110 of the base 102 respectively define a boundary, junction, and/or transition point between the border 104 of the drip tray 100 and the base 102 of the drip tray 100.

The drip tray 100 of FIGS. 1-10 further includes an example drain 112 formed in and/or extending through the base 102 of the drip tray 100. In the illustrated example of FIGS. 1-10, the drain 112 includes an example lip 114 projecting downwardly from the lower surface 202 of the base 102, with the lip 114 forming and/or terminating in an example lower edge 208 (e.g., a lower rim) thereof. The drain 112 further includes an example opening 116 extending through the upper surface 106 and the lower surface 202 of the base 102, with the opening 116 of the drain 112 being defined in part by the lip 114 of the drain 112. In the illustrated example of FIGS. 1-10, the lip 114 and the opening 116 of the drain 112 have a circular profile when viewed from the top side (e.g., as shown in FIG. 3) or the bottom side (e.g., as shown in FIG. 4) of the drip tray 100. In other examples, the lip 114 and the opening 116 of the drain 112 can instead have a different geometric-shaped profile (e.g., triangular, squared, rectangular, trapezoidal, hexagonal, octagonal, elliptical, etc.) when viewed from the top side or the bottom side of the drip tray 100. The drain 112 of the drip tray 100 is located inwardly from each one of the front edge 204, the rear edge 108, the right edge 206, and the left edge 110 of the base 102. The drain 112 is configured to facilitate the passage of grease downwardly (e.g., via gravity) through the drip tray 100 and toward and/or into a waste chute positioned below the lower surface 202 of the drip tray 100, and toward and/or into a waste bin positioned below the waste chute.

In the illustrated example of FIGS. 1-10, the upper surface 106 of the base 102 of the drip tray 100 includes an example first portion 118 and an example second portion 120. The first portion 118 of the upper surface 106 of the base 102 is located between the right edge 206 of the base 102 and the drain 112. The first portion 118 slopes downwardly from the right edge 206 of the base 102 toward the drain 112. The second portion 120 of the upper surface 106 of the base 102 is located between the left edge 110 of the base 102 and the drain 112. The second portion 120 slopes downwardly from the left edge 110 of the base 102 toward the drain 112. In the illustrated example of FIGS. 1-10, the upper surface 106 of the base 102 further includes an example first channel 122 and an example second channel 124. The first channel 122 is located between the first portion 118 and the second portion 120 of the upper surface 106 of the base 102, and further located between the front edge 204 of the base 102 and the drain 112. The first channel 122 slopes downwardly from the front edge 204 of the base 102 toward the drain 112. The second channel 124 is located between the first portion 118 and the second portion 120 of the upper surface 106 of the base 102, and further located between the rear edge 108 of the base 102 and the drain 112. The second channel 124 slopes downwardly from the rear edge 108 of the base 102 toward the drain 112. The aforementioned configuration of the drain 112, the first portion 118 of the base 102, the second portion 120 of the base 102, the first channel 122 of the base 102, and/or the second channel 124 of the base 102 of the drip tray 100 provides numerous benefits, including reducing the distance that grease which drips onto the upper surface 106 of the base 102 of the drip tray 100 must subsequently travel before such grease exits the drip tray 100 via the drain 112, and/or before such grease exits a cookbox of a grill within which the drip tray 100 may be positioned.

The drip tray 100 of FIGS. 1-10 further includes one or more example central vent(s) 126 formed in and/or extending through the base 102. In the illustrated example of FIGS. 1-10, the drip tray 100 includes a total of two such central vents 126 (e.g., implemented as an example first central vent 128 and an example second central vent 130), with such central vents 126 being spaced apart from one another on the base 102 of the drip tray 100. In other examples, the drip tray 100 can instead include a different number (e.g., one, three, four, six, etc.) of central vents 126. In the illustrated example of FIGS. 1-10, each one of the central vents 126 is oriented such that a longitudinal axis thereof extends in a side-to-side direction between the right edge 206 and the left edge 110 of the base 102 of the drip tray 100. In other examples, one or more of the central vents 126 can instead be oriented such that a longitudinal axis thereof extends in a front-to-rear direction between the front edge 204 and the rear edge 108 of the base 102 of the drip tray 100. In still other examples, one or more of the central vents 126 can instead be oriented such that a longitudinal axis thereof extends in an angled direction (e.g., between the right edge 206 and the rear edge 108 of the base 102 of the drip tray 100, between the left edge 110 and the rear edge 108 of the base 102 of the drip tray 100, etc.). In the illustrated example of FIGS. 1-10, each one of the central vents 126 is located exclusively within the first portion 118 of the base 102 of the drip tray 100. In other examples, one or more of the central vents 126 can instead be located partially or fully within the second portion 120 of the base 102 of the drip tray 100.

Each one of the central vents 126 (e.g., the first central vent 128 and the second central vent 130) of FIGS. 1-10 includes an example lip 132 projecting upwardly from the upper surface 106 of the base 102, with the lip 132 forming and/or terminating in an example upper edge 134 (e.g., an upper rim) thereof. Each one of the central vents 126 further includes an example opening 136 extending through the upper surface 106 and the lower surface 202 of the base 102, with the opening 136 of each one of the central vents 126 being defined in part by the lip 132 of the corresponding one of the central vents 126. In the illustrated example of FIGS. 1-10, the lip 132 and the opening 136 of each one of the central vents 126 have a rounded rectangular profile (e.g., a stadium-shaped profile) when viewed from the top side (e.g., as shown in FIG. 3) or the bottom side (e.g., as shown in FIG. 4) of the drip tray 100. In other examples, the lip 132 and the opening 136 of each one of the central vents 126 can instead have a different geometric-shaped profile (e.g., triangular, squared, rectangular, trapezoidal, hexagonal, octagonal, elliptical, etc.) when viewed from the top side or the bottom side of the drip tray 100. Each one of the central vents 126 (e.g., the first central vent 128 and the second central vent 130) of the drip tray 100 is located inwardly from each one of the front edge 204, the rear edge 108, the right edge 206, and the left edge 110 of the base 102. The central vents 126 are configured to facilitate the passage of heated air from one or more heat source(s) positioned below the drip tray 100 upwardly, through the central vents 126 of the drip tray 100, and toward one or more cooking grate(s) positioned above the drip tray 100.

In the illustrated example of FIGS. 1-10, the lip 132 of each one of the central vents 126 includes one or more example positioning notch(es) 138 formed in the lip 132 (e.g., along the upper edge 134 of the lip 132). Respective ones of positioning notch(es) 138 are configured to receive a mounting bracket of a vent shield when the vent shield is mounted on the lip 132 of the corresponding one of the central vents 126 with the mounting bracket positioned in the positioning notch(es) 138, as further described herein. In some examples, the lip 132 of each one of the central vents 126 further includes one or more example positioning flange(s) 140 formed by the lip 132 (e.g., along the upper edge 134 of the lip 132) and located adjacent one or more of the positioning notch(es) 138. Respective ones of the positioning flange(s) 140 are configured to restrict lateral movement of the mounting bracket of the vent shield relative to the corresponding one of the central vents 126 when the vent shield is mounted on the lip 132 of the corresponding one of the central vents 126 with the mounting bracket positioned adjacent the positioning flange(s) 140, as further described herein. The aforementioned configuration of the central vents 126 (e.g., including the vent shields mounted thereon) provides numerous benefits, including (1) directing heated air produced by one or more heat source(s) located below the drip tray 100 to migrate upwardly through the central vents 126 of the drip tray 100 to one or more cooking grate(s) located above the drip tray 100, (2) preventing undesirable combustion byproducts (e.g., ash) produced by one or more heat source(s) located below the drip tray 100 from migrating upwardly through the central vents 126 of the drip tray 100 to one or more cooking grate(s) located above the drip tray 100, and (3) preventing grease that drips from one or more cooking grate(s) downwardly onto the base 102 of the drip tray 100 from passing downwardly through the central vents 126 formed in the base 102 of the drip tray 100 onto and/or into one or more heat source(s) located below the drip tray 100.

As discussed above, the border 104 of the drip tray 100 of FIGS. 1-10 circumscribes and/or otherwise surrounds a periphery of the base 102 of the drip tray 100. As shown in FIGS. 1-10, the border 104 projects upwardly and outwardly from the upper surface 106 of the base 102 along the front edge 204, the rear edge 108, the right edge 206, and the left edge 110 of the base 102. The border 104 of FIGS. 1-10 accordingly includes an example front portion 142 located adjacent the front edge 204 of the base 102, an example rear portion 144 located adjacent the rear edge 108 of the base 102, an example right portion 146 located adjacent the right edge 206 of the base 102, and an example left portion 148 located adjacent the left edge 110 of the base 102. The border 104 (e.g., including each of the front portion 142, the rear portion 144, the right portion 146, and the left portion 148 thereof) of FIGS. 1-10 includes an example inner wall 150, an example outer wall 152, and a plurality of example peripheral vents 154. Respective ones of the peripheral vents 154 are formed in and/or extend through the inner wall 150 of the border 104. In some examples, the respective ones of the peripheral vents 154 are formed in and/or extend through the inner wall 150 of the border 104 along two or more of the front portion 142, the rear portion 144, the right portion 146, and the left portion 148 of the border 104. For example, as shown in FIGS. 1-10, the respective ones of the peripheral vents 154 are formed in and/or extend through the inner wall 150 of the border 104 along all four of the front portion 142, the rear portion 144, the right portion 146, and the left portion 148 of the border 104. In the illustrated example of FIGS. 1-10, the respective ones of the peripheral vents 154 have a rounded rectangular profile (e.g., a stadium-shaped profile). In other examples, the respective ones of the peripheral vents 154 can instead have a different geometric-shaped profile (e.g., triangular, squared, rectangular, trapezoidal, hexagonal, octagonal, elliptical, etc.).

In the illustrated example of FIGS. 1-10, the inner wall 150 of the border 104 projects upwardly and outwardly from the upper surface 106 of the base 102, and the outer wall 152 of the border 104 projects downwardly and outwardly from the inner wall 150 (e.g., from an upper edge of the inner wall 150) of the border 104. In such examples, the border 104 of the drip tray 100 has an inverted V-shaped cross-sectional profile formed by the inner wall 150 and the outer wall 152 of the border 104, as generally shown in FIGS. 9 and 10. In other examples, the inner wall 150 and the outer wall 152 of the border 104 can form and/or be part of a different geometric-shaped cross-sectional profile (e.g., an inverted L-shaped cross-sectional profile, an inverted U-shaped cross-sectional profile, etc.) of the border 104. In the illustrated example of FIGS. 1-10, the border 104 forms an example upper rim 156 of the drip tray 100. The border 104 of FIGS. 1-10 further includes a plurality of example positioning notches 158 formed in the outer wall 152 (e.g., along a lower edge of the outer wall 152) of the border 104. Respective ones of the positioning notches 158 are configured to receive corresponding respective ones of a plurality of mounting structures (e.g., projections, ribs, flanges, bosses, etc.) formed (e.g., integrally formed) on and/or along an interior surface of a sidewall of a cookbox of a grill. In some examples, the respective ones of the positioning notches 158 are formed in the outer wall 152 of the border 104 along two or more of the front portion 142, the rear portion 144, the right portion 146, and the left portion 148 of the border 104. For example, as shown in FIGS. 1-10, the border 104 includes positioning notches 158 formed in the outer wall 152 of the border 104 along the right portion 146 and the left portion 148 of the border 104. In some examples, the respective ones of the positioning notches 158 of the border 104 are asymmetrically arranged, thereby preventing the drip tray 100 from being installed in any orientation aside from and/or other than the specific orientation in which the drip tray 100 is intended to be installed within a cookbox of a grill. The aforementioned configuration of the border 104 (e.g., including the peripheral vents 154 formed therein) provides numerous benefits, including (1) minimizing the gap distance existing between the outer wall 152 of the border 104 of the drip tray 100 and an interior surface of a sidewall of a cookbox within which the drip tray 100 may be positioned, and (2) evenly distributing heated air produced by one or more heat source(s) located below the drip tray 100 as such heated air migrates upwardly through the peripheral vents 154 formed in the border 104 of the drip tray 100 to one or more cooking grate(s) positioned above the drip tray 100.

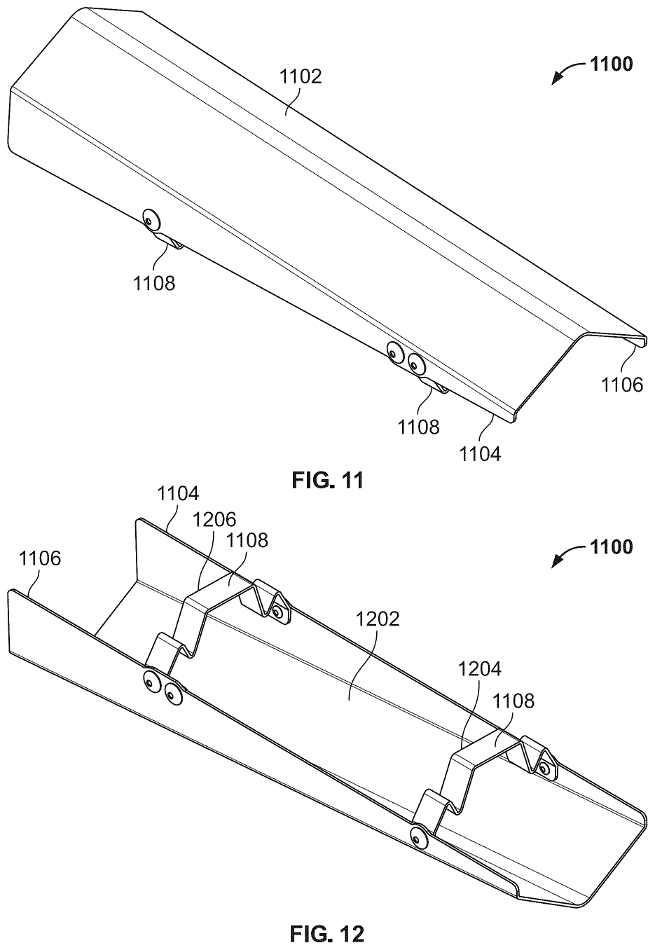

FIG. 11 is a first perspective view of an example vent shield 1100 constructed in accordance with the teachings of this disclosure. FIG. 12 is a second perspective view of the vent shield 1100 of FIG. 11. The vent shield 1100 of FIGS. 11 and 12 includes an example upper surface 1102, an example lower surface 1202, an example first lower edge 1104, and an example second lower edge 1106. The lower surface 1202 of the vent shield 1100 is located opposite the upper surface 1102 of the vent shield 1100. The second lower edge 1106 of the vent shield 1100 is spaced apart from and located opposite the first lower edge 1104 of the vent shield 1100. In the illustrated example of FIGS. 11 and 12, the vent shield 1100 has an inverted V-shaped cross-sectional profile that leads to and-or terminates in the first lower edge 1104 and the second lower edge 1106 of the vent shield 1100. The vent shield 1100 of FIGS. 11 and 12 is configured to cover the opening 136 of a central vent (e.g., the first central vent 128 or the second central vent 130) of the drip tray 100 when the vent shield 1100 is mounted on the lip 132 of the central vent. In this regard, the vent shield 1100 is configured such that the first lower edge 1104 and the second lower edge 1106 of the vent shield 1100 extend downwardly toward and/or about a periphery of the upper edge 134 of the lip 132 of a central vent (e.g., the first central vent 128 or the second central vent 130) of the drip tray 100 when the vent shield 1100 is mounted on the lip 132 of the central vent.

The vent shield 1100 of FIGS. 11 and 12 further include one or more example mounting bracket(s) 1108 located along and/or below the lower surface 1202 of the vent shield 1100, with each one of the mounting bracket(s) 1108 being configured to facilitate mounting and/or positioning the vent shield 1100 on the lip 132 of a central vent (e.g., the first central vent 128 or the second central vent 130), as further described below. In the illustrated example of FIGS. 11 and 12, the vent shield 1100 includes a total of two such mounting brackets 1108 (e.g., implemented as an example first mounting bracket 1204 and an example second mounting bracket 1206), with such mounting brackets 1108 being spaced apart from one another on the vent shield 1100. In other examples, the vent shield 1100 can instead include a different number (e.g., one, three, four, six, etc.) of mounting brackets 1108. In the illustrated example of FIGS. 11 and 12, each one of the mounting brackets 1108 extends between the first lower edge 1104 and the second lower edge 1106 of the vent shield 1100. In other examples, one or more of the mounting brackets 1108 can instead extend in a different direction and/or between different portions of the vent shield 1100. Each one of the mounting brackets 1108 (e.g., the first mounting bracket 1204 and the second mounting bracket 1206) of the vent shield 1100 of FIGS. 11 and 12 is configured to be positioned within one or more of the positioning notch(es) 138 formed in the lip 132 of one of the central vents 126 (e.g., the first central vent 128 or the second central vent 130) of the drip tray 100 and/or to be positioned adjacent one or more of the positioning flange(s) 140 formed by the lip 132 of a corresponding one of the central vents 126 of the drip tray 100 when the vent shield 1100 is mounted and/or positioned on the lip 132 of the corresponding one of the central vents 126, as further described herein.

The aforementioned configuration of the vent shield 1100 of FIGS. 11 and 12 provides numerous benefits, including (1) preventing undesirable combustion byproducts (e.g., ash) produced by one or more heat source(s) located below the drip tray 100 from migrating upwardly through the central vents 126 of the drip tray 100 to one or more cooking grate(s) located above the drip tray 100, and (2) preventing grease that drips from one or more cooking grate(s) downwardly onto the base 102 of the drip tray 100 from passing downwardly through the central vents 126 formed in the base 102 of the drip tray 100 onto and/or into one or more heat source(s) located below the drip tray 100.

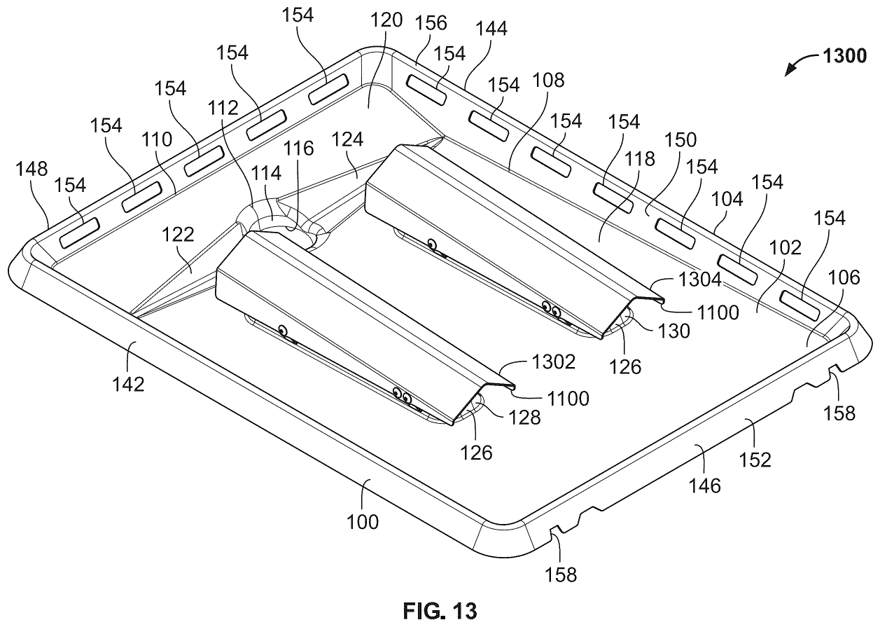

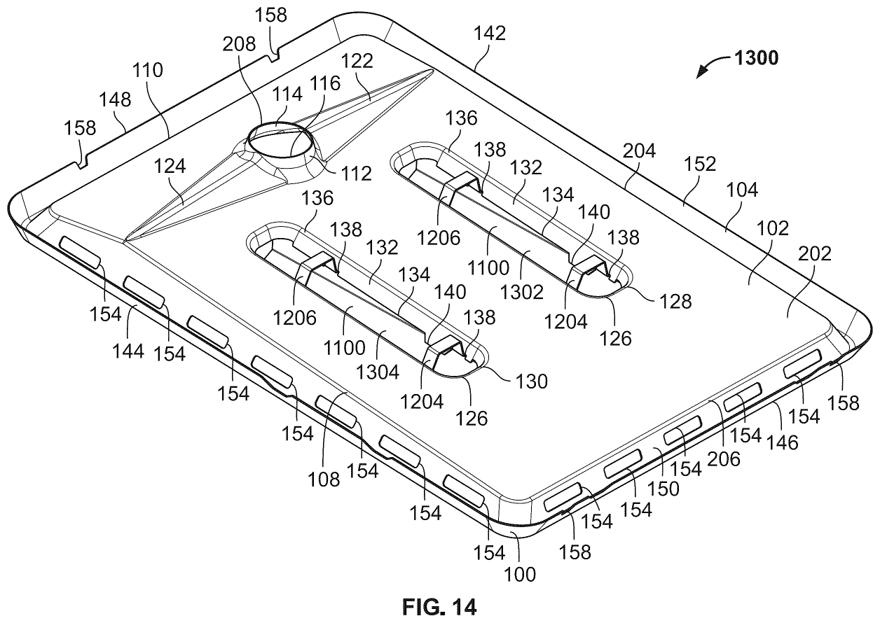

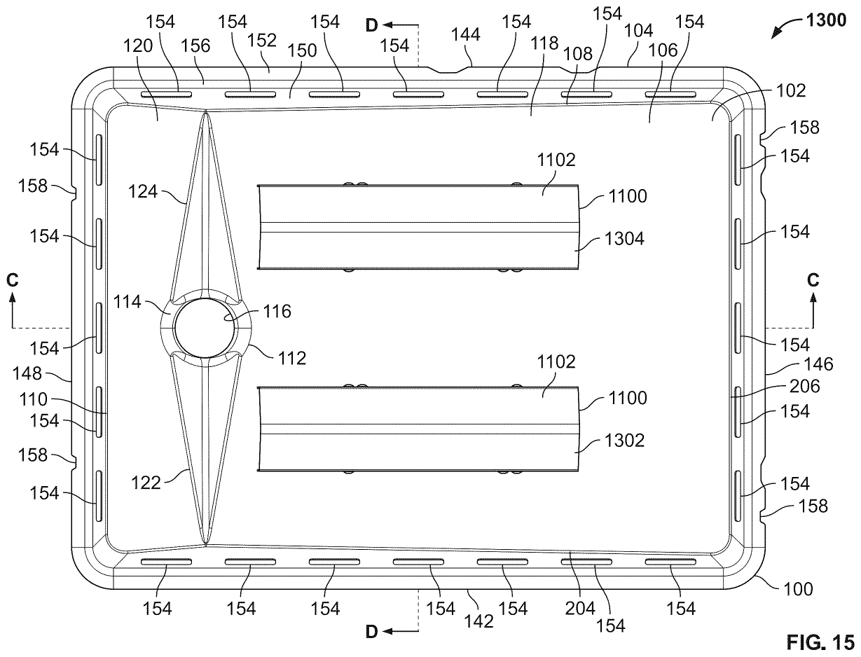

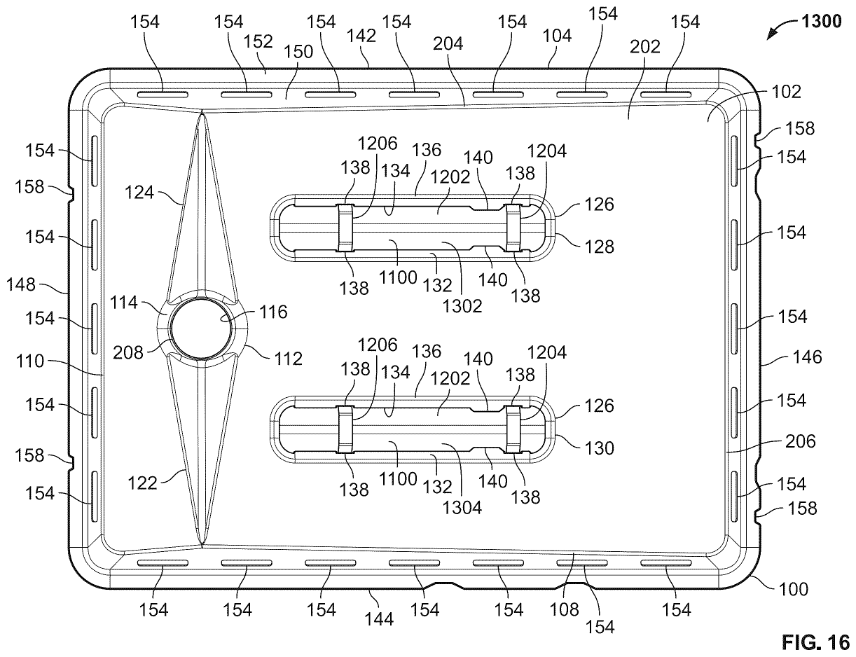

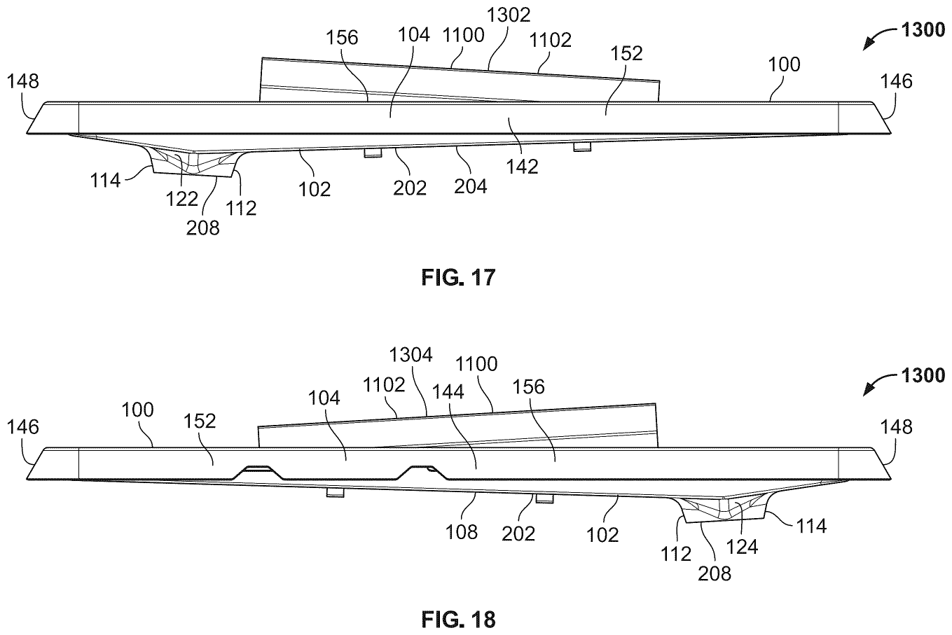

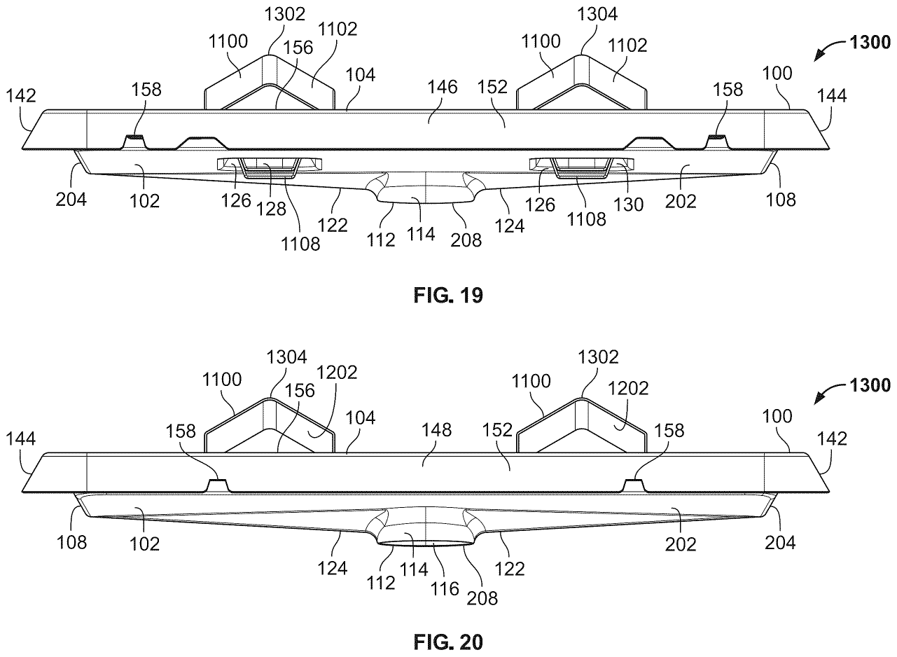

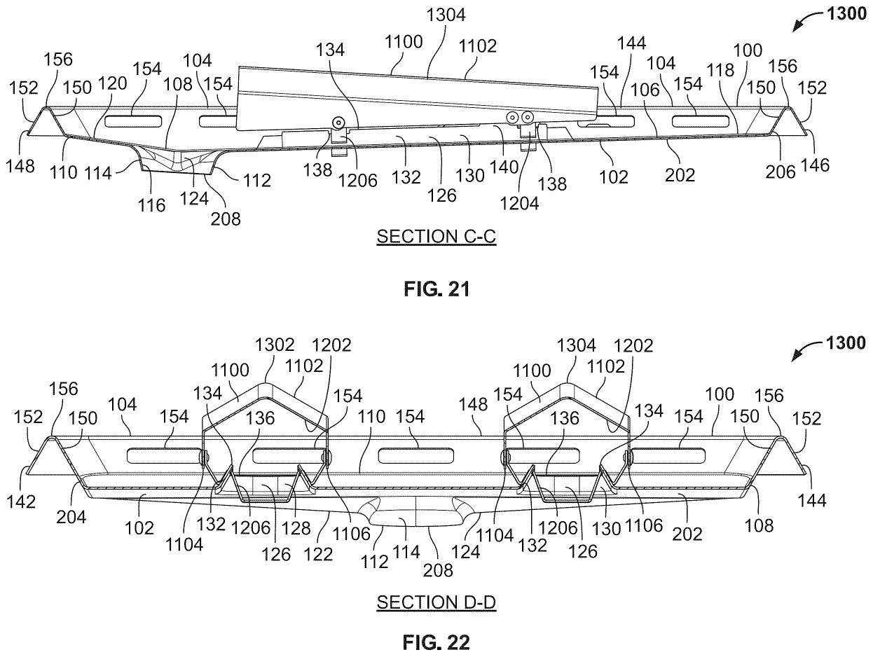

FIG. 13 is a first perspective view of an example drip tray assembly 1300 constructed in accordance with the teachings of this disclosure. FIG. 14 is a second perspective view of the drip tray assembly 1300 of FIG. 13. FIG. 15 is a top view of the drip tray assembly 1300 of FIGS. 13 and 14. FIG. 16 is a bottom view of the drip tray assembly 1300 of FIGS. 13-15. FIG. 17 is a front view of the drip tray assembly 1300 of FIGS. 13-16. FIG. 18 is a rear view of the drip tray assembly 1300 of FIGS. 13-17. FIG. 19 is a right side view of the drip tray assembly 1300 of FIGS. 13-18. FIG. 20 is a left side view of the drip tray assembly 1300 of FIGS. 13-19. FIG. 21 is a cross-sectional view of the drip tray assembly 1300 of FIGS. 13-20 taken along section C-C of FIG. 15. FIG. 22 is a cross-sectional view of the drip tray assembly 1300 of FIGS. 13-21 taken along section D-D of FIG. 15.

The drip tray assembly 1300 of FIGS. 13-22 includes the drip tray 100 of FIGS. 1-10 and two instances of the vent shield 1100 of FIGS. 11 and 12. More specifically, the drip tray assembly 1300 of FIGS. 13-22 includes an example first vent shield 1302 mounted and/or positioned on the lip 132 of the first central vent 128 of the drip tray 100 of FIGS. 1-10 such that the first vent shield 1302 covers the opening 136 of the first central vent 128, and an example second vent shield 1304 mounted and/or positioned on the lip 132 of the second central vent 130 of the drip tray 100 such that the second vent shield 1304 covers the opening 136 of the second central vent 130. In this regard, the first lower edge 1104 and the second lower edge 1106 of the first vent shield 1302 extend downwardly toward and/or about a periphery of the upper edge 134 of the lip 132 of the first central vent 128, and the first lower edge 1104 and the second lower edge 1106 of the second vent shield 1304 extend downwardly toward and/or about a periphery of the upper edge 134 of the lip 132 of the second central vent 130.

In the illustrated example of FIGS. 13-22, the first vent shield 1302 and the second vent shield 1304 are removably mountable on corresponding ones of the first central vent 128 and the second central vent 130 such that the first vent shield 1302 and the second vent shield 1304 can advantageously be removed from the drip tray 100 for cleaning. Mounting and/or positioning of the first vent shield 1302 and the second vent shield 1304 relative to corresponding ones of the first central vent 128 and the second central vent 130 is accomplished via a combination of the mounting brackets of the vent shields on the one hand and the positioning notches and/or the positioning flanges of the central vents on the other hand. For example, as shown via the drip tray assembly 1300 FIGS. 13-22, the first mounting bracket 1204 and the second mounting bracket 1206 of the first vent shield 1302 are respectively positioned within one or more of the positioning notch(es) 138 formed in the lip 132 of the first central vent 128 of the drip tray 100. The first mounting bracket 1204 of the first vent shield 1302 is further positioned adjacent one or more of the positioning flange(s) 140 formed by the lip 132 of the first central vent 128 of the drip tray 100. Similarly, the first mounting bracket 1204 and the second mounting bracket 1206 of the second vent shield 1304 are respectively positioned within one or more of the positioning notch(es) 138 formed in the lip 132 of the second central vent 130 of the drip tray 100. The first mounting bracket 1204 of the second vent shield 1304 is further positioned adjacent one or more of the positioning flange(s) 140 formed by the lip 132 of the second central vent 130 of the drip tray 100.

The aforementioned configuration of the drip tray assembly 1300 of FIGS. 13-22 provides numerous benefits, including: (1) directing heated air produced by one or more heat source(s) located below the drip tray 100 to migrate upwardly through the first central vent 128 and/or the second central vent 130 of the drip tray 100 to one or more cooking grate(s) located above the drip tray 100, (2) preventing undesirable combustion byproducts (e.g., ash) produced by one or more heat source(s) located below the drip tray 100 from migrating upwardly through the first central vent 128 and/or the second central vent 130 of the drip tray 100 to one or more cooking grate(s) located above the drip tray 100, (3) preventing grease that drips from one or more cooking grate(s) downwardly onto the base 102 of the drip tray 100 from passing downwardly through the first central vent 128 and/or the second central vent 130 formed in the base 102 of the drip tray 100 onto and/or into one or more heat source(s) located below the drip tray 100, (4) minimizing the gap distance existing between the outer wall 152 of the border 104 of the drip tray 100 and an interior surface of a sidewall of a cookbox within which the drip tray 100 may be positioned, (5) evenly distributing heated air produced by one or more heat source(s) located below the drip tray 100 as such heated air migrates upwardly through the peripheral vents 154 formed in the border 104 of the drip tray 100 to one or more cooking grate(s) positioned above the drip tray 100, and (6) reducing the distance that grease which drips onto the upper surface 106 of the base 102 of the drip tray 100 must subsequently travel before such grease exits the drip tray 100 via the drain 112 formed in the base 102 of the drip tray 100, and/or before such grease exits a cookbox of a grill within which the drip tray 100 may be positioned.

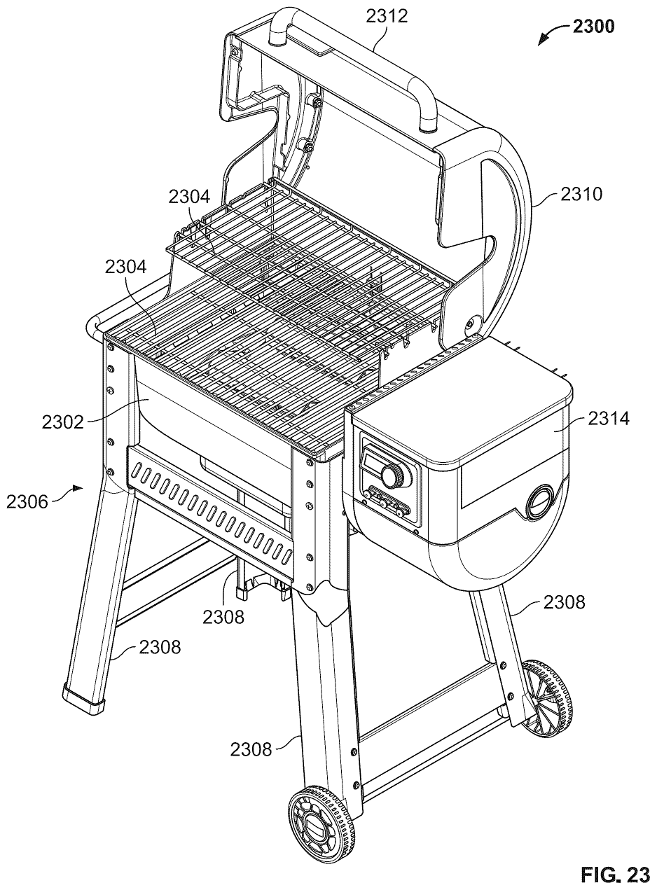

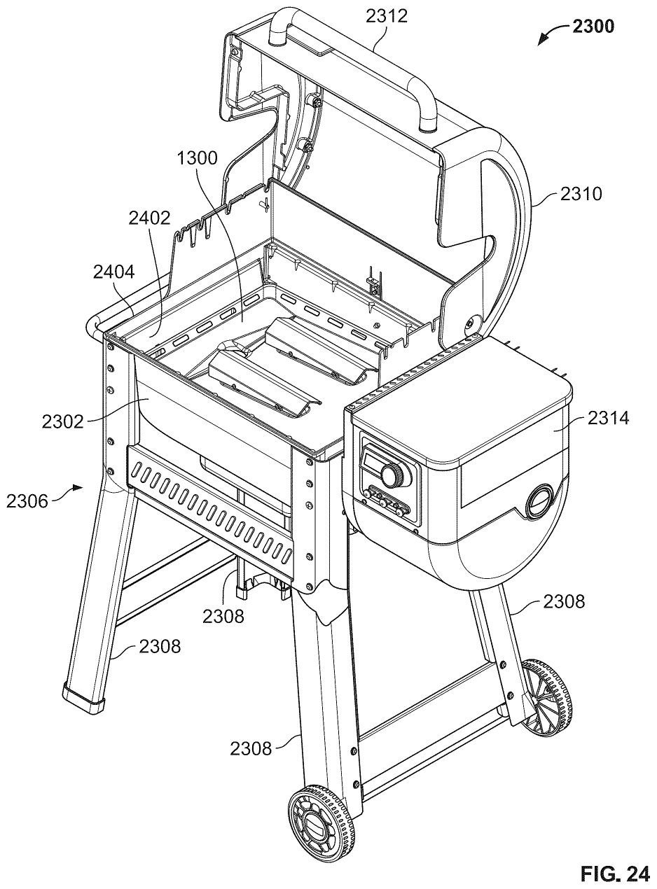

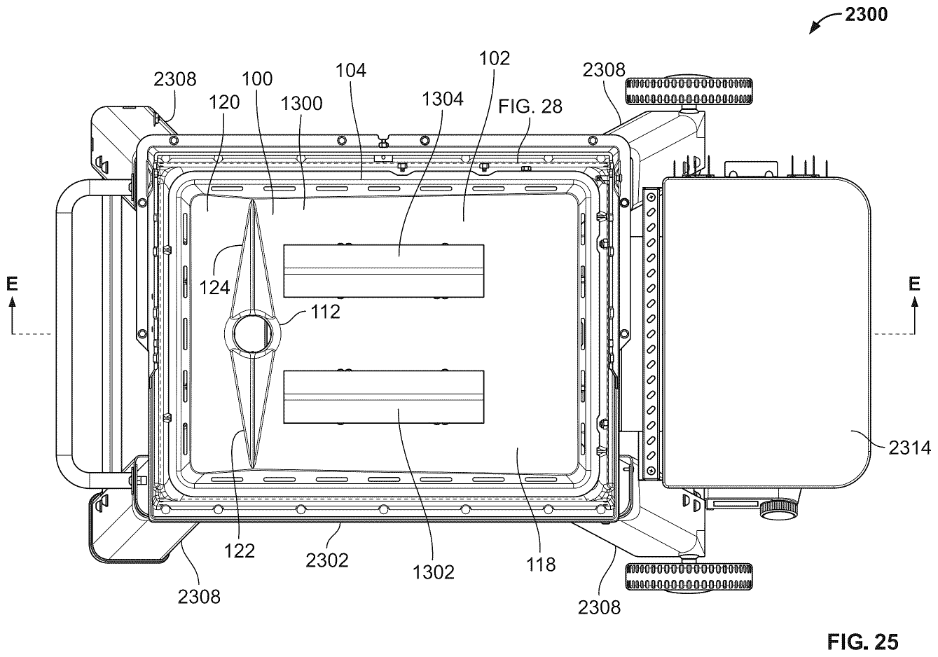

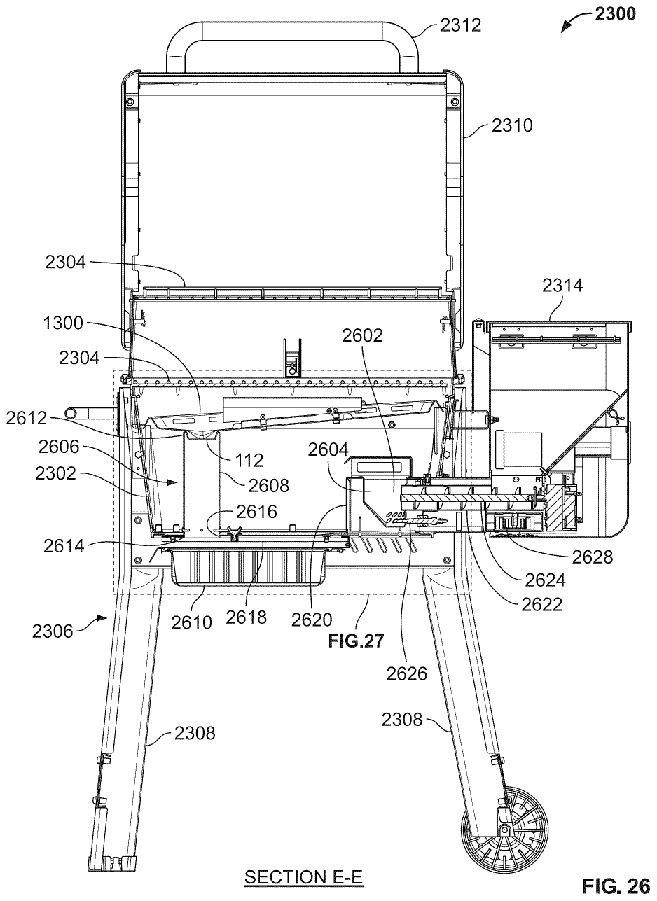

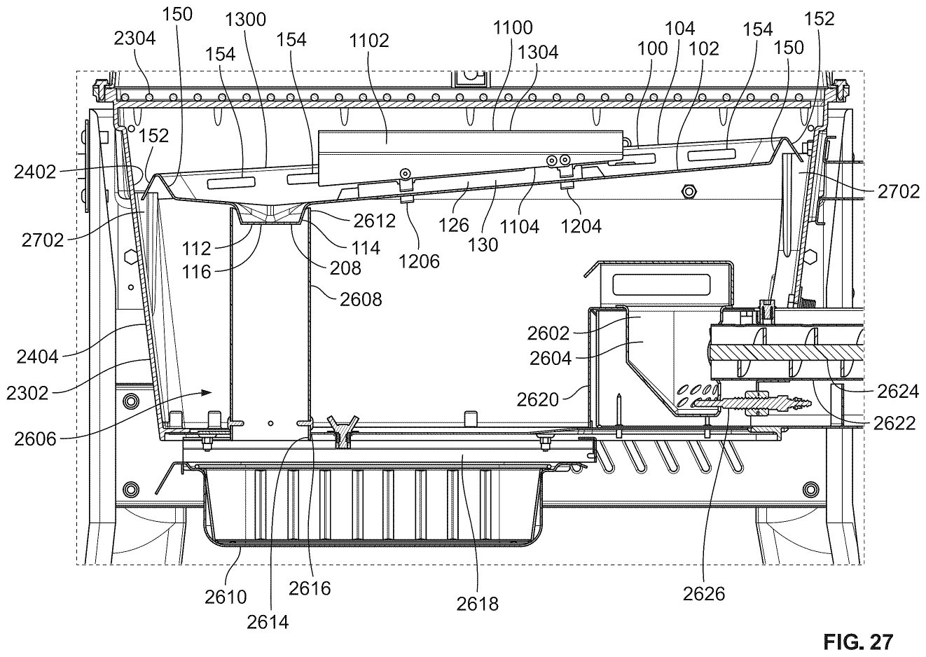

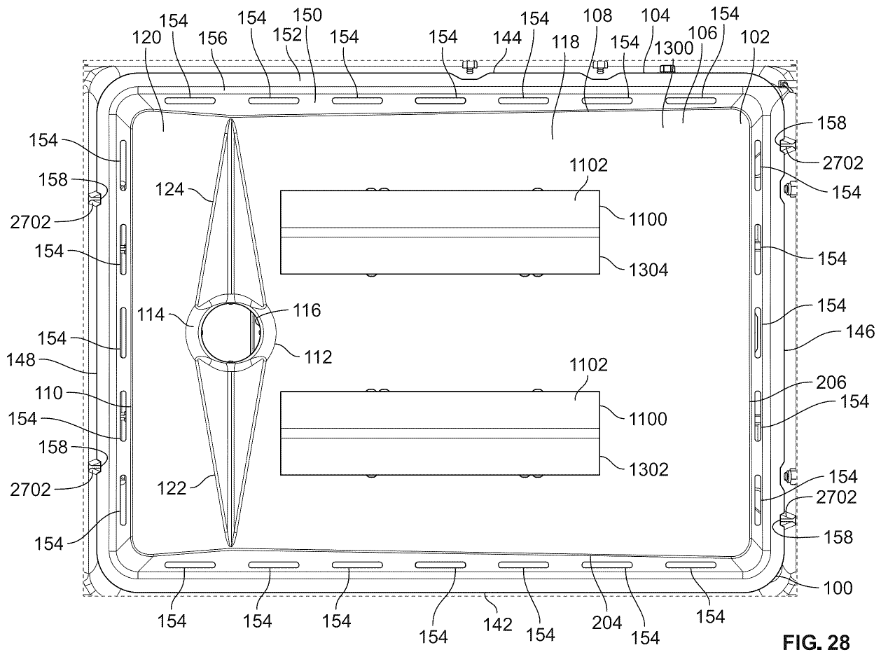

FIG. 23 is a perspective view of an example grill 2300 including the drip tray assembly 1300 of FIGS. 13-22. FIG. 24 is a perspective view of the grill 2300 of FIG. 23, shown with the cooking grates of the grill 2300 removed to better illustrate the drip tray assembly 1300. FIG. 25 is a top view of the grill 2300 of FIGS. 23 and 24, shown with the cooking grates and the lid of the grill 2300 removed to better illustrate the drip tray assembly 1300. FIG. 26 is a cross-sectional view of the grill 2300 of FIGS. 23-25 taken along section E-E of FIG. 25. FIG. 27 is an enlarged view of a portion of FIG. 26. FIG. 28 is an enlarged view of a portion of FIG. 25.

The grill 2300 of FIGS. 23-28 includes an example cookbox 2302 that is configured to form a portion of a cooking chamber of the grill 2300. In the illustrated example of FIGS. 23-28, the cookbox 2302 is advantageously implemented as a cast aluminum cookbox. More specifically, the cookbox 2302 of FIGS. 23-28 is made from aluminum and formed via a casting process. Fabrication of the cookbox 2302 via the casting process advantageously results in the entirety of the cookbox 2302 being formed as an integral, single-piece structure that is free of joints, seams, and welds. In other examples, the cookbox 2302 can be formed via a casting process, but made from a metal other than aluminum. In still other examples, the cookbox 2302 can be formed from a manufacturing process other than casting, and can be made either from aluminum or from a metal other than aluminum

In addition to the cookbox 2302 of FIGS. 23-28 forming a portion of the cooking chamber of the grill 2300, the cookbox 2302 is further configured to house, carry, and/or support one or more structure(s) associated with various cooking processes that can be performed within the cooking chamber. In this regard, the cookbox 2302 of FIGS. 23-28 is configured to house, carry, and/or support one or more example cooking grate(s) 2304 and one or more example heat source(s) 2602, with the heat source(s) 2602 being located and/or positioned within the cookbox 2302 below a location and/or position of the cooking grate(s) 2304. In the illustrated example of FIGS. 23-28, the grill 2300 is implemented as a pellet grill, and the heat source(s) 2602 is/are implemented by and/or as an example burn pot 2604, with the burn pot 2604 being configured to generate and/or emit heat derived from the combustion of wood pellets located therein. In examples where the grill 2300 is instead implemented as a gas grill, the heat source(s) 2602 of the grill 2300 can be implemented by and/or as one or more burner tube(s) configured to generate and/or emit a heat-producing gas flame. In examples where the grill 2300 is implemented as an electric grill, the heat source(s) 2602 of the grill 2300 can be implemented by and/or as one or more electric heating element(s) configured to generate and/or emit heat in response to electrical power supplied thereto. In examples where the grill 2300 is implemented as a charcoal grill, a fuel grate can be located and/or positioned within the cookbox 2302, with the fuel grate being configured to support charcoal while the charcoal undergoes a heat-generating combustion process.

The cookbox 2302 of the grill 2300 of FIGS. 23-28 is further configured to house, carry, and/or support the drip tray assembly 1300 of FIGS. 13-22 described above, with the drip tray assembly 1300 being located and/or positioned within the cookbox 2302 below a location and/or position of the cooking grate(s) 2304 and above a location and/or position of the heat source(s) 2602. In the illustrated example of FIGS. 23-28, the outer wall 152 of the border 104 of the drip tray 100 is mounted, positioned, and/or otherwise disposed on and/or along an example interior surface 2402 of an example sidewall 2404 of the cookbox 2302 of the grill 2300. More specifically, the cookbox 2302 of the grill 2300 of FIGS. 23-28 includes one or more example mounting structure(s) 2702 (e.g., projections, ribs, flanges, bosses, etc.) formed (e.g., integrally formed) on and/or along the interior surface 2402 of the sidewall 2404 of the cookbox 2302, with respective ones of the mounting structure(s) 2702 being configured to be received within corresponding respective ones of the positioning notch(es) 158 formed in the outer wall 152 of the border 104 of the drip tray 100, as best shown in FIG. 28. The aforementioned configuration of the grill 2300 and the drip tray assembly 1300 results in the border 104 of the drip tray 100 being spaced apart from the interior surface 2402 of the sidewall 2404 of the cookbox 2302 by a gap distance that is preferably less than 0.50 inches, and more preferably less than 0.25 inches.

The cookbox 2302 of the grill 2300 of FIGS. 23-28 is further configured to house, carry, and/or support an example waste management assembly 2606 of the grill 2300. In the illustrated example of FIGS. 23-28, the waste management assembly 2606 of the grill 2300 includes an example waste chute 2608 and an example waste bin 2610. The waste chute 2608 is located and/or positioned between the drip tray 100 and the waste bin 2610. In this regard, the waste chute 2608 includes an example open upper end 2612 that faces upwardly toward the lower surface 202 of the base 102 of the drip tray 100 and an example open lower end 2614 that faces downwardly toward the waste bin 2610. In the illustrated example of FIGS. 23-28, the open lower end 2614 of the waste chute 2608 extends to and/or through an example opening 2616 formed in and/or extending through a bottom wall of the cookbox 2302, with the waste bin 2610 of the waste management assembly 2606 being located and/or positioned below the opening 2616.

The waste chute 2608 of FIGS. 23-28 is further configured such that the open upper end 2612 of the waste chute 2608 circumscribes and/or otherwise surrounds the lower edge 208 of the lip 114 of the drain 112 of the drip tray 100, and such that the open lower end 2614 of the waste chute 2608 is circumscribed and/or otherwise surrounded by a periphery of an upper rim of the waste bin 2610. The waste chute 2608 accordingly provides a pathway by which grease entering the drain 112 of the drip tray 100 can pass downwardly through the waste chute 2608, out of the cookbox 2302 via the opening 2616 formed in the bottom wall of the cookbox 2302, and into the waste bin 2610. The aforementioned pathway is effectively configured as a closed pathway that prevents grease received on the upper surface 106 of the base 102 of the drip tray 100 from dripping onto and/or into the heat source(s) 2602 of the grill 2300 as such grease is removed from the cookbox 2302 of the grill 2300. The waste bin 2610 is slidably coupled to the bottom wall of the cookbox 2302 via a pair of example support rail(s) 2618, thereby enabling the waste bin 2610 to be slid out from beneath the cookbox 2302 for the purpose of emptying any waste (e.g., grease) contained within the waste bin 2610.

The grill 2300 of FIGS. 23-28 further includes an example frame 2306. In the illustrated example of FIGS. 23-28, the frame 2306 includes one or more example support member(s) 2308 (e.g., one or more vertically oriented leg(s)) that are configured to support the cookbox 2302 and/or the waste management assembly 2606 above an underlying ground surface. The support member(s) 2308 and/or, more generally, the frame 2306 can be configured from any number and any type of structural components arranged in any manner that facilitates supporting the cookbox 2302 and/or the waste management assembly 2606 above an underlying ground surface when the grill 2300 is in use. For example, while each of the one or more support member(s) 2308 shown in FIGS. 23-28 is fixed relative to the cookbox 2302, in other examples the frame 2306 can include one or more foldable, slidable, and/or telescoping support member(s) 2308 that facilitate collapsing and/or otherwise modifying the frame 2306 of the grill 2300 when the grill 2300 is not in use.

The grill 2300 of FIGS. 23-28 further includes an example lid 2310 configured to cover and/or enclose the cookbox 2302 of the grill 2300 when the lid 2310 is in a closed position. The lid 2310 is movable relative to the cookbox 2302 between a closed position and an open position in which the cooking grate(s) 2304 located on or within the cookbox 2302 are exposed. In the illustrated example of FIGS. 23-28, the lid 2310 is pivotally coupled to the cookbox 2302 via one or more hinge(s) and/or pivot(s) that mechanically couple the lid 2310 to the cookbox 2302. Movement of the lid 2310 of the grill 2300 between the closed position and the open position can be facilitated via user interaction with an example handle 2312 that is coupled to the lid 2310.

In the illustrated example of FIGS. 23-28, the grill 2300 is configured as a pellet grill. In this regard, the grill 2300 of FIGS. 23-28 includes an example hopper 2314 coupled to the cookbox 2302 and/or to the frame 2306, with the hopper 2314 being configured to hold and/or contain a supply of combustible wood pellets. The grill 2300 of FIGS. 23-28 further includes an example ducted housing 2620, an example auger duct 2622, an example auger 2624, the burn pot 2604, an example ignitor 2626, and an example fan 2628. The ducted housing 2620, the auger duct 2622, and the auger 2624 respectively extend from the hopper 2314 of the grill 2300, through a side opening formed in the sidewall 2404 of the cookbox 2302, and into a cooking chamber of the cookbox 2302 defined in part by the interior surface 2402 of the cookbox 2302. The auger 2624 is located within the auger duct 2622, and the auger duct 2622 is located within the ducted housing 2620.

The burn pot 2604 of the grill 2300 is located within the ducted housing 2620. In the illustrated example of FIGS. 23-28, the auger 2624 and the auger duct 2622 respectively extend to and/or or into the burn pot 2604 such that that auger 2624 and the auger duct 2622 collectively transport wood pellets from the hopper 2314 into the burn pot 2604. Combustion of the wood pellets received in the burn pot 2604 can be initiated via activation of the ignitor 2626 which, like the burn pot 2604, is also located within the ducted housing 2620. In this regard, a heat-generating portion (e.g., an ignition tip) of the ignitor 2626 extends into the burn pot 2604 such that the heat-generating portion of the ignitor 2626 contacts at least some of the wood pellets received in the burn pot 2604. Once combustion of the wood pellets received in the burn pot 2604 has commenced via the ignition process, the rate of such combustion can be managed via a controlled airflow generated by the fan 2628, with said airflow being delivered from the fan 2628 into the ducted housing 2620, and through the ducted housing 2620 to the burn pot 2604. Heated air generated by and/or as a result of the combustion of the wood pellets within the burn pot 2604 thereafter rises from the burn pot 2604, through the central vents 126 formed in the base 102 of the drip tray 100 and/or through the peripheral vents 154 formed in the border 104 of the drip tray 100, upwardly toward and/or to the cooking grate(s) 2304 of the grill 2300.

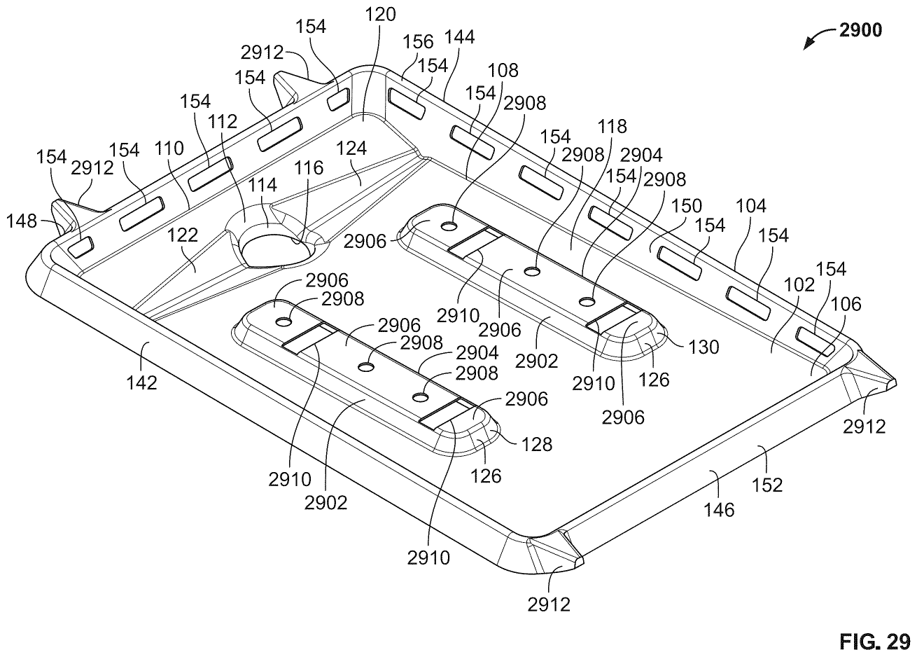

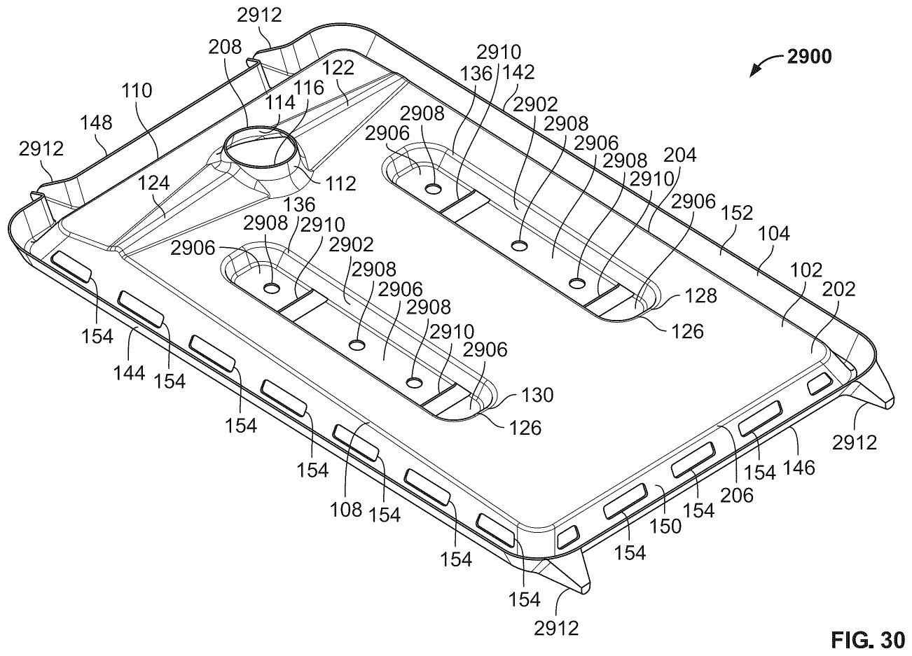

FIG. 29 is a first perspective view of another example drip tray 2900 constructed in accordance with the teachings of this disclosure. FIG. 30 is a second perspective view of the drip tray 2900 of FIG. 29. The drip tray 2900 of FIGS. 29 and 30 is configured in a manner that is generally consistent with and/or relative to the configuration of the drip tray 100 of FIGS. 1-10 described above. In this regard, the drip tray 2900 of FIGS. 29 and 30 includes a base 102 (e.g., having an upper surface 106, a lower surface 202, a front edge 204, a rear edge 108, a right edge 206, a left edge 110, a drain 112, a first portion 118, a second portion 120, a first channel 122, a second channel 124, a first central vent 128, and a second central vent 130), and a border 104 (e.g., having a front portion 142, a rear portion 144, a right portion 146, a left portion 148, an inner wall 150, an outer wall 152, and a plurality of peripheral vents 154) that are respectively configured in a manner that is generally consistent with and/or relative to the configuration of those same structural features of the drip tray 100 of FIGS. 1-10 described above. The drip tray 2900 of FIGS. 29 and 30 primarily differs from the drip tray 100 of FIGS. 1-10 in two ways, each of which is discussed in greater detail below.

A first difference between the drip tray 2900 of FIGS. 29 and 30 and the drip tray 100 of FIGS. 1-10 pertains to the configuration of the lip of each one of the central vents (e.g., the first central vent 128 and the second central vent 130). As discussed above in relation to the drip tray 100 of FIGS. 1-10, the lip 132 of each one of the central vents 126 (e.g., the first central vent 128 and the second central vent 130) projects upwardly from the upper surface 106 of the base 102, with the lip 132 forming and/or terminating in an upper edge 134 (e.g., an upper rim), and with the upper edge 134 including and/or defining one or more positioning notch(es) 138 and/or one or more positioning flange(s) 140, wherein respective ones of the positioning notch(es) 138 are configured to receive a mounting bracket of a vent shield when the vent shield is mounted on the lip 132 of the corresponding one of the central vents 126, and wherein respective ones of the positioning flange(s) 140 are configured to restrict lateral movement of the mounting bracket of the vent shield relative to the corresponding one of the central vents 126 when the vent shield is mounted on the lip 132 of the corresponding one of the central vents 126 with the mounting bracket positioned adjacent the positioning flange(s) 140. As shown in the illustrated example of FIGS. 1-10, the spatial area located inwardly from the upper edge 134 of the corresponding one of the central vents 126 is generally unoccupied, unfilled, unobstructed, and/or uncovered by any structural feature and/or component that is integrally formed with the drip tray 100 itself.

By contrast, each one of the central vents 126 (e.g., the first central vent 128 and the second central vent 130) of the drip tray 2900 of FIGS. 29 and 30 includes an example lip 2902 that projects upwardly from the upper surface 106 of the base 102, with the lip 2902 forming and/or terminating in an example upper edge 2904, and with the upper edge 2904 further being defined in part by one or more example cover segment(s) 2906, with each one of the cover segment(s) 2906 bridging and/or spanning across the lip 2902 proximate the upper edge 2904 thereof so as to occupy, fill, obstruct, and/or cover a corresponding portion of the spatial area located inwardly from the upper edge 2904 of the corresponding one of the central vents 126. In the illustrated example of FIGS. 29 and 30, each one of the cover segment(s) 2906 is integrally formed with the lip 2902 of the corresponding one of the central vents 126. As further shown in the illustrated example of FIGS. 29 and 30, at least one of the one or more cover segment(s) 2906 includes one or more example opening(s) 2908 formed therein, with each such opening 2908 being configured to enable heated air to pass upwardly through the corresponding one of the cover segment(s) 2906.

As further shown in the illustrated example of FIGS. 29 and 30, neighboring ones of the cover segments 2906 are spaced apart from one another via an example positioning gap 2910. Each positioning gap 2910 is configured to receive a mounting bracket of a vent shield when the vent shield is mounted on the lip 2902 of the corresponding one of the central vents 126. The neighboring ones of the cover segments 2906 that define each positioning gap 2910 are configured to restrict lateral movement of the mounting bracket of the vent shield relative to the corresponding one of the central vents 126 when the vent shield is mounted on the lip 2902 of the corresponding one of the central vents 126 with the mounting bracket positioned in the positioning gap 2910. Accordingly, functions performed by the positioning notches 138 and the positioning flanges 140 of each one of the central vents 126 of the drip tray 100 of FIGS. 1-10 are instead performed by the positioning gaps 2910 and the cover segments 2906 of each one of the central vents 126 of the drip tray 2900 of FIGS. 29 and 30.

A second difference between the drip tray 2900 of FIGS. 29 and 30 and the drip tray 100 of FIGS. 1-10 pertains to the configuration of the border 104 and, more specifically, to the configuration of the mounting structure(s) of the border 104 by which the drip tray is to be positioned within a cookbox of a grill. As discussed above in relation to the drip tray 100 of FIGS. 1-10, the border 104 includes a plurality of positioning notches 158 formed in the outer wall 152 (e.g., along a lower edge of the outer wall 152) of the border 104, wherein respective ones of the positioning notches 158 are configured to receive corresponding respective ones of a plurality of mounting structures (e.g., projections, ribs, flanges, bosses, etc.) formed (e.g., integrally formed) on and/or along an interior surface of a sidewall of a cookbox of a grill. As shown in FIGS. 1-10, the positioning notches 158 are formed in the outer wall 152 of the border 104 along the right portion 146 and the left portion 148 of the border 104. The positioning notches 158 are beneficial for implementations in which there is a need to minimize the gap distance existing between the outer wall 152 of the border 104 of the drip tray 100 and an interior surface of a sidewall of a cookbox within which the drip tray 100 may be positioned.

By contrast, the border 104 of the drip tray 2900 of FIGS. 29 and 30 includes a plurality of example mounting supports 2912 extending outwardly from the outer wall 152 of the border 104. In the illustrated example of FIGS. 29 and 30, the mounting supports 2912 are integrally formed with the outer wall 152 of the border 104 such that the outer wall 152 of the border 104 and the mounting supports 2912 constitute a single, continuous piece of material that is free of joints, seams, and/or welds. In other examples, one or more of the mounting supports 2912 can instead be coupled (e.g., via one or more fastener(s)) to the outer wall 152 of the border 104 in a manner that results in one or more joint(s), seam(s), and/or weld(s) being formed between the outer wall 152 of the border 104 and the one or more of the mounting supports 2912. In the illustrated example of FIGS. 29 and 30, respective ones of the mounting supports 2912 are configured to be seated on and/or to receive corresponding respective ones of a plurality of mounting structures (e.g., projections, ribs, flanges, bosses, etc.) formed (e.g., integrally formed) on and/or along an interior surface of a sidewall of a cookbox of a grill. Accordingly, functions performed by the positioning notches 158 of the border 104 of the drip tray 100 of FIGS. 1-10 are instead performed by the mounting supports 2912 of the border 104 of the drip tray 2900 of FIGS. 29 and 30.

In some examples, the respective ones of the mounting supports 2912 of the drip tray 2900 of FIGS. 29 and 30 extend outwardly from the outer wall 152 of the border 104 along two or more of the front portion 142, the rear portion 144, the right portion 146, and the left portion 148 of the border 104. For example, as shown in FIGS. 29 and 30, the border 104 includes mounting supports 2912 that extend outwardly from the outer wall 152 of the border 104 along the right portion 146 and the left portion 148 of the border 104. In some examples, the respective ones of the mounting supports 2912 of the border 104 are asymmetrically arranged, thereby preventing the drip tray 2900 from being installed in any orientation aside from and/or other than the specific orientation in which the drip tray 2900 is intended to be installed within a cookbox of a grill.

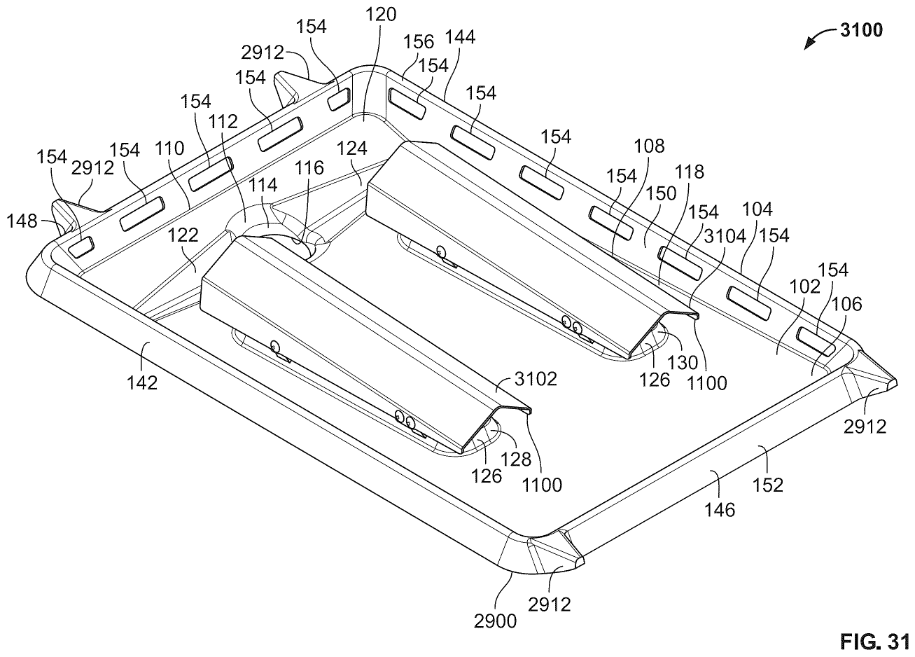

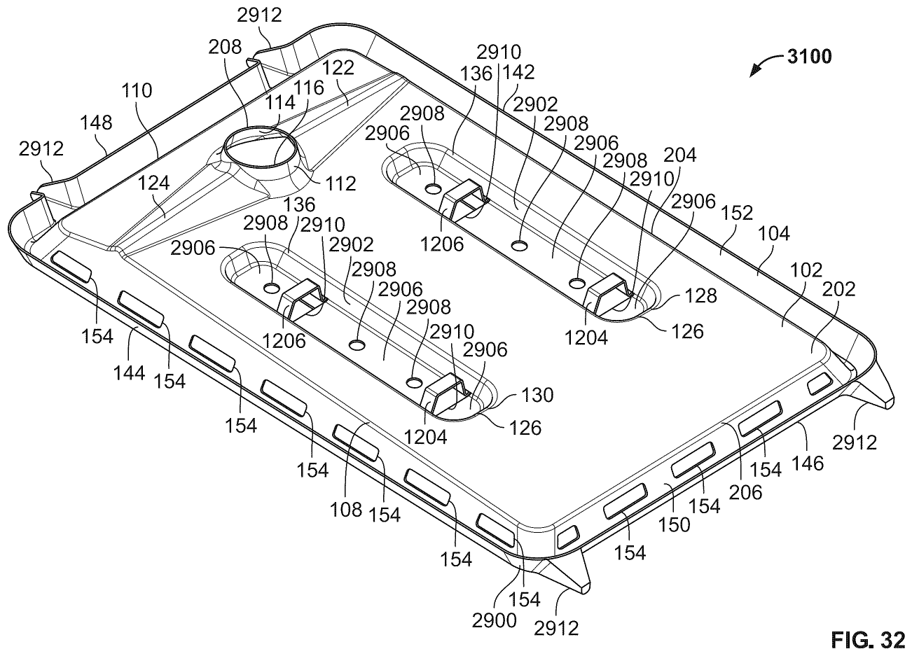

FIG. 31 is a first perspective view of another example drip tray assembly 3100 constructed in accordance with the teachings of this disclosure. FIG. 32 is a second perspective view of the drip tray assembly 3100 of FIG. 31. The drip tray assembly 3100 of FIGS. 31 and 32 includes the drip tray 2900 of FIGS. 29 and 30 and two instances of the vent shield 1100 of FIGS. 11 and 12. More specifically, the drip tray assembly 3100 of FIGS. 31 and 32 includes an example first vent shield 3102 mounted and/or positioned on the lip 2902 of the first central vent 128 of the drip tray 2900 of FIGS. 29 and 30 such that the first vent shield 3102 covers the opening(s) 2908 of the first central vent 128, and an example second vent shield 3104 mounted and/or positioned on the lip 2902 of the second central vent 130 of the drip tray 2900 such that the second vent shield 3104 covers the opening(s) 2908 of the second central vent 130. In this regard, the first lower edge 1104 and the second lower edge 1106 of the first vent shield 3102 extend downwardly toward and/or about a periphery of the upper edge 2904 of the lip 2902 of the first central vent 128, and the first lower edge 1104 and the second lower edge 1106 of the second vent shield 3104 extend downwardly toward and/or about a periphery of the upper edge 2904 of the lip 2902 of the second central vent 130.

In the illustrated example of FIGS. 31 and 32, the first vent shield 3102 and the second vent shield 3104 are removably mountable on corresponding ones of the first central vent 128 and the second central vent 130 such that the first vent shield 3102 and the second vent shield 3104 can advantageously be removed from the drip tray 2900 for cleaning. Mounting and/or positioning of the first vent shield 3102 and the second vent shield 3104 relative to corresponding ones of the first central vent 128 and the second central vent 130 is accomplished via a combination of the mounting brackets of the vent shields on the one hand and the positioning gaps 2910 of the central vents on the other hand. For example, as shown via the drip tray assembly 3100 FIGS. 31 and 32, the first mounting bracket 1204 and the second mounting bracket 1206 of the first vent shield 3102 are respectively positioned within corresponding first and second ones of the positioning gaps 2910 located along the upper edge 2904 of the lip 2902 of the first central vent 128 of the drip tray 2900. Similarly, the first mounting bracket 1204 and the second mounting bracket 1206 of the second vent shield 3104 are respectively positioned within corresponding first and second ones of the positioning gaps 2910 located along the upper edge 2904 of the lip 2902 of the second central vent 130 of the drip tray 2900.

The aforementioned configuration of the drip tray assembly 3100 of FIGS. 31 and 32 provides numerous benefits, including: (1) directing heated air produced by one or more heat source(s) located below the drip tray 2900 to migrate upwardly through the first central vent 128 and/or the second central vent 130 of the drip tray 2900 to one or more cooking grate(s) located above the drip tray 2900, (2) preventing undesirable combustion byproducts (e.g., ash) produced by one or more heat source(s) located below the drip tray 2900 from migrating upwardly through the first central vent 128 and/or the second central vent 130 of the drip tray 2900 to one or more cooking grate(s) located above the drip tray 2900, (3) preventing grease that drips from one or more cooking grate(s) downwardly onto the base 102 of the drip tray 2900 from passing downwardly through the first central vent 128 and/or the second central vent 130 formed in the base 102 of the drip tray 2900 onto and/or into one or more heat source(s) located below the drip tray 2900, (4) evenly distributing heated air produced by one or more heat source(s) located below the drip tray 2900 as such heated air migrates upwardly through the peripheral vents 154 formed in the border 104 of the drip tray 100 to one or more cooking grate(s) positioned above the drip tray 2900, and (5) reducing the distance that grease which drips onto the upper surface 106 of the base 102 of the drip tray 2900 must subsequently travel before such grease exits the drip tray 2900 via the drain 112 formed in the base 102 of the drip tray 2900, and/or before such grease exits a cookbox of a grill within which the drip tray 2900 may be positioned.

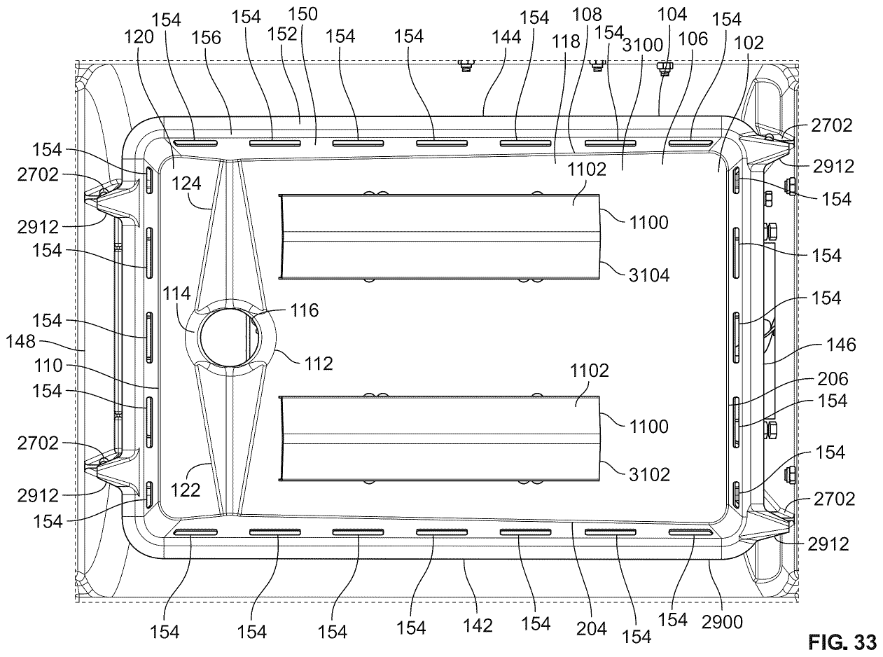

FIG. 33 corresponds to the grill 2300 of FIGS. 23-28 as shown in FIG. 28, but including the drip tray assembly 3100 of FIGS. 31 and 32 in lieu of the drip tray assembly 1300 of FIGS. 13-22. As shown in FIG. 33, respective ones of the mounting supports 2912 that extend outwardly from the outer wall 152 of the border 104 of the drip tray 2900 are mounted, positioned, and/or otherwise disposed on and/or along the interior surface 2402 of the sidewall 2404 of the cookbox 2302 of the grill 2300. More specifically, the cookbox 2302 of the grill 2300 includes one or more mounting structure(s) 2702 (e.g., projections, ribs, flanges, bosses, etc.) formed (e.g., integrally formed) on and/or along the interior surface 2402 of the sidewall 2404 of the cookbox 2302, with respective ones of the mounting structure(s) 2702 being configured to support and/or to be received within corresponding respective ones of the mounting supports 2912 that extend outwardly from the outer wall 152 of the border 104 of the drip tray 2900, as shown in FIG. 33.

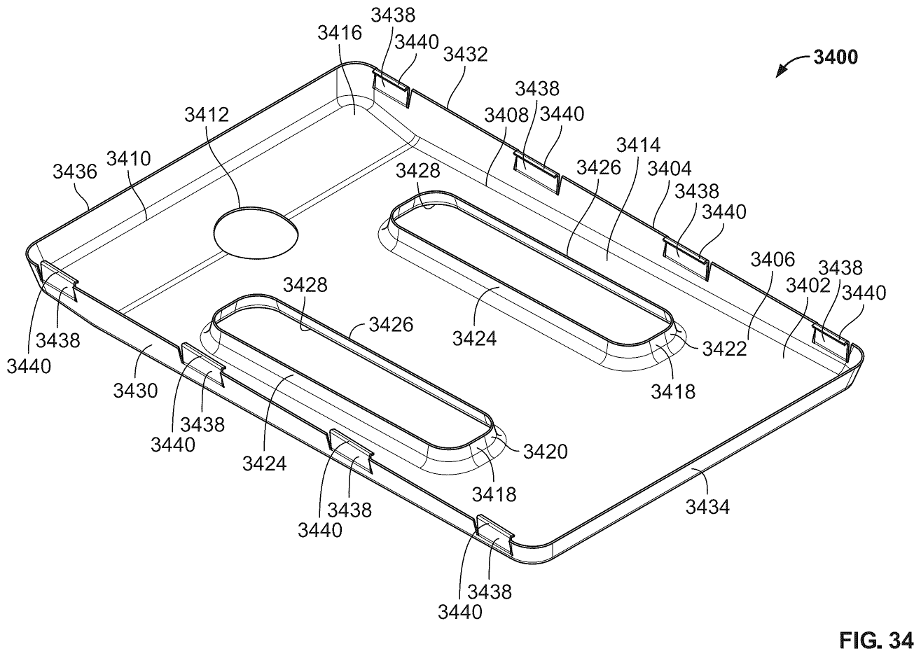

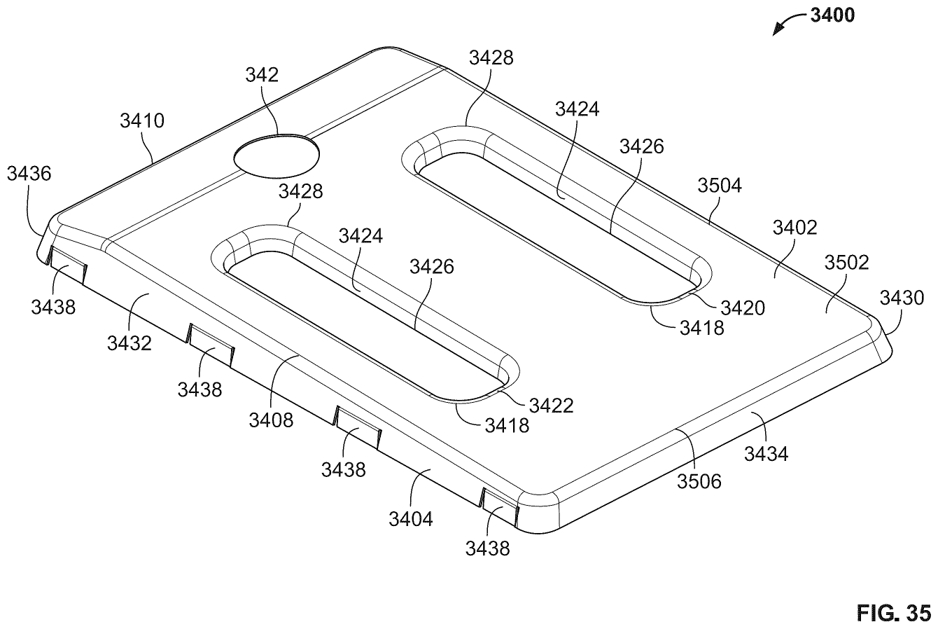

FIG. 34 is a first perspective view of an example heat shield 3400 constructed in accordance with the teachings of this disclosure. FIG. 35 is a second perspective view of the heat shield 3400 of FIG. 34. The configuration of the heat shield 3400 of FIGS. 34 and 35 mimics and/or complements the configuration of the drip tray 100 of FIGS. 1-10 and/or the configuration of the drip tray 2900 of FIGS. 29 and 30 in many respects, as further described herein.

The heat shield 3400 of FIGS. 34 and 35 includes an example base 3402 and an example border 3404. The border 3404 of the heat shield 3400 circumscribes and/or otherwise surrounds a periphery of the base 3402 of the heat shield 3400. In the illustrated example of FIGS. 34 and 35, the border 3404 is integrally formed with the base 3402 such that the base 3402 and the border 3404 constitute a single, continuous piece of material that is free of joints, seams, and/or welds. In other examples, the border 3404 can instead be coupled to the base 3402 in a manner that results in one or more joint(s), seam(s), and/or weld(s) being formed between the border 3404 and the base 3402. In the illustrated example of FIGS. 34 and 35, the heat shield 3400 (e.g., including the base 3402 and the border 3404 thereof) has a generally rectangular profile when viewed from the top side or the bottom side thereof. In other examples, the heat shield 3400 can instead have a different geometric-shaped profile (e.g., triangular, squared, trapezoidal, hexagonal, octagonal, circular, elliptical, etc.) when viewed from the top side or the bottom side thereof.

The base 3402 of the heat shield 3400 of FIGS. 34 and 35 includes an example upper surface 3406, an example lower surface 3502, an example front edge 3504, an example rear edge 3408, an example right edge 3506, and an example left edge 3410. The lower surface 3502 of the base 3402 is located opposite the upper surface 3406 of the base 3402. The rear edge 3408 of the base 3402 is spaced apart from and located opposite the front edge 3504 of the base 3402. The right edge 3506 and the left edge 3410 of the base 3402 respectively extend between the front edge 3504 and the rear edge 3408 of the base 3402, with the left edge 3410 of the base 3402 being spaced apart from and located opposite the right edge 3506 of the base 3402. The front edge 3504, the rear edge 3408, the right edge 3506, and the left edge 3410 of the base 3402 respectively define a boundary, junction, and/or transition point between the border 3404 of the heat shield 3400 and the base 3402 of the heat shield 3400.

The heat shield 3400 of FIGS. 34 and 35 further includes an example opening 3412 formed in and/or extending through the base 3402 of the heat shield 3400 (e.g., extending through the upper surface 3406 and the lower surface 3502 of the base 3402). In the illustrated example of FIGS. 34 and 35, the opening 3412 has a circular profile when viewed from the top side or the bottom side of the heat shield 3400. In other examples, the opening 3412 can instead have a different geometric-shaped profile (e.g., triangular, squared, rectangular, trapezoidal, hexagonal, octagonal, elliptical, etc.) when viewed from the top side or the bottom side of the heat shield 3400. The opening 3412 of the heat shield 3400 is located inwardly from each one of the front edge 3504, the rear edge 3408, the right edge 3506, and the left edge 3410 of the base 3402. The opening 3412 of the heat shield 3400 is configured to circumscribe and/or to receive the lip 114 of the drain 112 of a drip tray (e.g., the drip tray 100 of FIGS. 1-10, the drip tray 2900 of FIGS. 29 and 30, etc.) when the heat shield 3400 is coupled to the drip tray (e.g., as further described herein), thereby facilitating the passage of grease downwardly (e.g., via gravity) through the drain 112 of the drip tray and toward and/or into a waste chute positioned below the drip tray and/or below the heat shield 3400, and toward and/or into a waste bin positioned below the waste chute.

In the illustrated example of FIGS. 34 and 35, the upper surface 3406 of the base 3402 of the heat shield 3400 includes an example first portion 3414 and an example second portion 3416. The first portion 3414 of the upper surface 3406 of the base 3402 is located between the right edge 3506 of the base 3402 and the opening 3412. The first portion 3414 slopes downwardly from the right edge 3506 of the base 3402 toward the opening 3412. The second portion 3416 of the upper surface 3406 of the base 3402 is located between the left edge 3410 of the base 3402 and the opening 3412. The second portion 3416 slopes downwardly from the left edge 3410 of the base 3402 toward the opening 3412.

The heat shield 3400 of FIGS. 34 and 35 further includes one or more example central vent(s) 3418 formed in and/or extending through the base 3402. In the illustrated example of FIGS. 34 and 35, the heat shield 3400 includes a total of two such central vents 3418 (e.g., implemented as an example first central vent 3420 and an example second central vent 3422), with such central vents 3418 being spaced apart from one another on the base 3402 of the heat shield 3400. In other examples, the heat shield 3400 can instead include a different number (e.g., one, three, four, six, etc.) of central vents 3418. In the illustrated example of FIGS. 34 and 35, each one of the central vents 3418 is oriented such that a longitudinal axis thereof extends in a side-to-side direction between the right edge 3506 and the left edge 3410 of the base 3402 of the heat shield 3400. In other examples, one or more of the central vents 3418 can instead be oriented such that a longitudinal axis thereof extends in a front-to-rear direction between the front edge 3504 and the rear edge 3408 of the base 3402 of the heat shield 3400. In still other examples, one or more of the central vents 3418 can instead be oriented such that a longitudinal axis thereof extends in an angled direction (e.g., between the right edge 3506 and the rear edge 3408 of the base 3402 of the heat shield 3400, between the left edge 3410 and the rear edge 3408 of the base 3402 of the heat shield 3400, etc.). In the illustrated example of FIGS. 34 and 35, each one of the central vents 3418 is located exclusively within the first portion 3414 of the base 3402 of the heat shield 3400. In other examples, one or more of the central vents 3418 can instead be located partially or fully within the second portion 3416 of the base 3402 of the heat shield 3400.

Each one of the central vents 3418 (e.g., the first central vent 3420 and the second central vent 3422) of FIGS. 34 and 35 includes an example lip 3424 projecting upwardly from the upper surface 3406 of the base 3402, with the lip 3424 forming and/or terminating in an example upper edge 3426 (e.g., an upper rim) thereof. Each one of the central vents 3418 further includes an example opening 3428 extending through the upper surface 3406 and the lower surface 3502 of the base 3402, with the opening 3428 of each one of the central vents 3418 being defined in part by the lip 3424 of the corresponding one of the central vents 3418. In the illustrated example of FIGS. 34 and 35, the lip 3424 and the opening 3428 of each one of the central vents 3418 have a rounded rectangular profile (e.g., a stadium-shaped profile) when viewed from the top side or the bottom side of the heat shield 3400. In other examples, the lip 3424 and the opening 3428 of each one of the central vents 3418 can instead have a different geometric-shaped profile (e.g., triangular, squared, rectangular, trapezoidal, hexagonal, octagonal, elliptical, etc.) when viewed from the top side or the bottom side of the heat shield 3400. Each one of the central vents 3418 (e.g., the first central vent 3420 and the second central vent 3422) of the heat shield 3400 is located inwardly from each one of the front edge 3504, the rear edge 3408, the right edge 3506, and the left edge 3410 of the base 3402. The central vents 3418 are configured to facilitate the passage of heated air from one or more heat source(s) positioned below the heat shield 3400 upwardly, through the central vents 3418 of the heat shield 3400, toward a drip tray (e.g., the drip tray 100 of FIGS. 1-10, the drip tray 2900 of FIGS. 29 and 30, etc.) positioned above the heat shield, and/or toward one or more cooking grate(s) positioned above the drip tray.

As discussed above, the border 3404 of the heat shield 3400 of FIGS. 34 and 35 circumscribes and/or otherwise surrounds a periphery of the base 3402 of the heat shield 3400. As shown in FIGS. 34 and 35, the border 3404 projects upwardly from the upper surface 3406 of the base 3402 along the front edge 3504, the rear edge 3408, the right edge 3506, and the left edge 3410 of the base 3402. The border 3404 of FIGS. 34 and 35 accordingly includes an example front portion 3430 located adjacent the front edge 3504 of the base 3402, an example rear portion 3432 located adjacent the rear edge 3408 of the base 3402, an example right portion 3434 located adjacent the right edge 3506 of the base 3402, and an example left portion 3436 located adjacent the left edge 3410 of the base 3402.

The border 3404 of the heat shield 3400 of FIGS. 34 and 35 includes a plurality of example mounting clips 3438 formed (e.g., integrally formed) by and/or along two or more of the front portion 3430, the rear portion 3432, the right portion 3434, and the left portion 3436 of the border 3404. For example, as shown in FIGS. 34 and 35, the respective ones of the mounting clips 3438 are formed (e.g., integrally formed) by and/or along the front portion 3430 and the rear portion 3432 of the border 3404. In other examples, the respective ones of the mounting clips 3438 can instead be formed (e.g., integrally formed) by and/or along all the right portion 3434 and the left portion 3436 of the border 3404. In still other examples, the respective ones of the mounting clips 3438 can instead be formed (e.g., integrally formed) by and/or along all four of the front portion 3430, the rear portion 3432, the right portion 3434, and the left portion 3436 of the border 3404. Each one of the mounting clips 3438 is at least partially flexible (e.g., semi-flexible) relative to a surrounding local surface of the border 3404. In the illustrated example of FIGS. 34 and 35, each one of the mounting clips 3438 includes an example tab 3440 (e.g., located at a free end of each one of the mounting clips 3438) that extends inwardly from and/or relative to the surrounding local surface of the border 3404. The tab 3440 of each one of the mounting clips 3438 is configured to be received within a corresponding one of the peripheral vents 154 formed in the inner wall 150 of the border 104 of a drip tray (e.g., the drip tray 100 of FIGS. 1-10, the drip tray 2900 of FIGS. 29 and 30, etc.), thereby coupling (e.g., clipping) the heat shield 3400 to the drip tray, as further described herein.

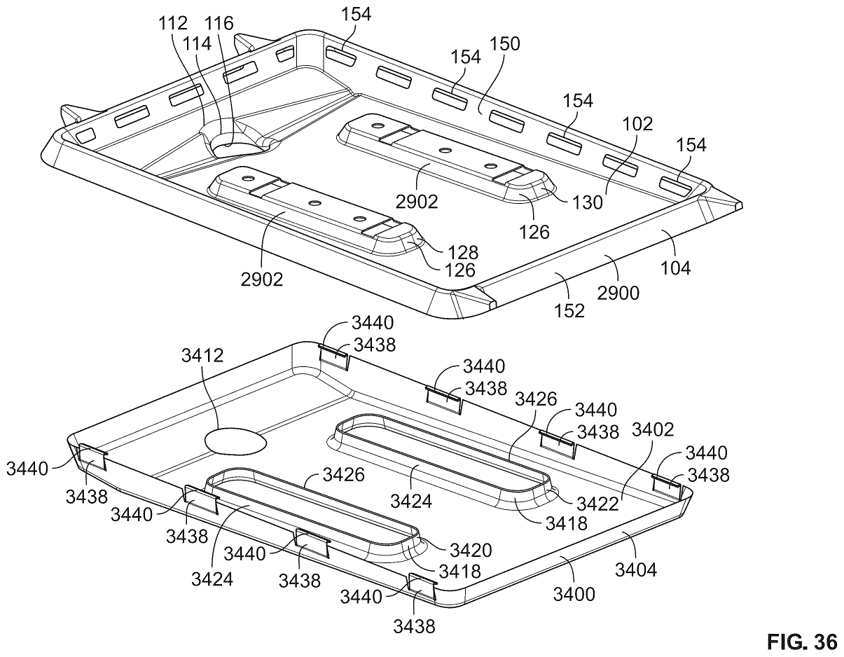

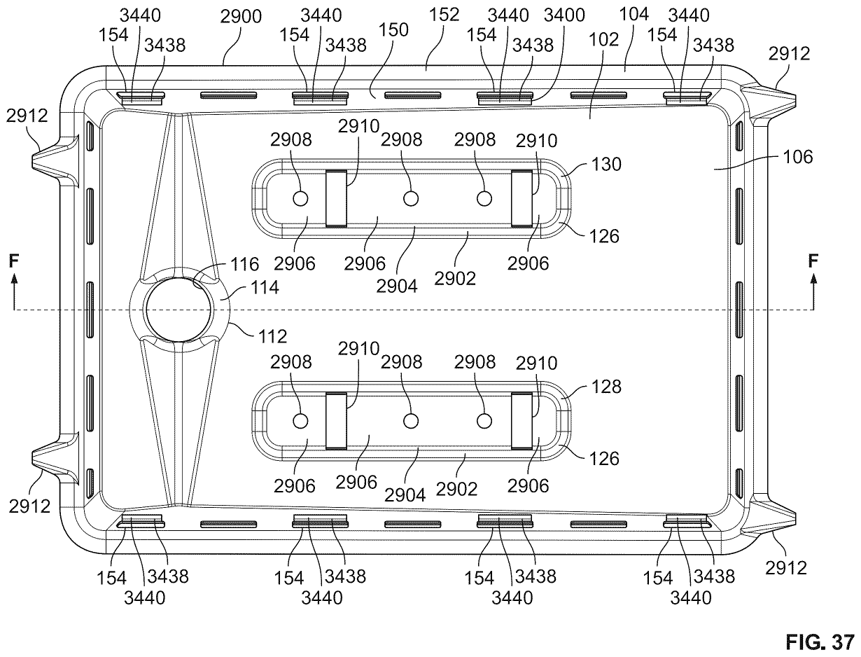

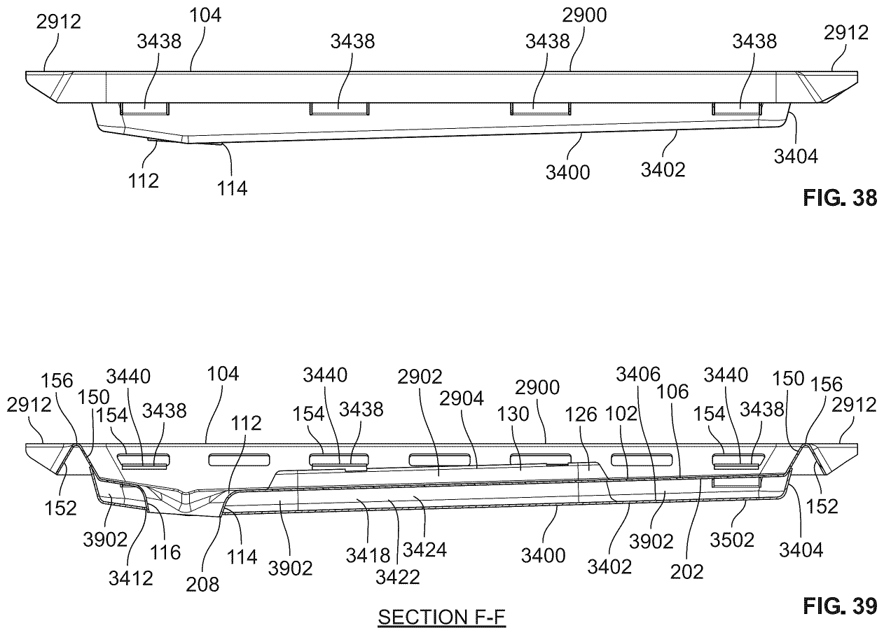

The heat shield 3400 of FIGS. 34 and 35 is configured to be coupled (e.g., removably coupled) to a drip tray (e.g., the drip tray 100 of FIGS. 1-10, the drip tray 2900 of FIGS. 29 and 30, etc.). FIG. 36 is an exploded view illustrating the heat shield 3400 of FIGS. 34 and 35 relative to the drip tray 2900 of FIGS. 29 and 30. FIG. 37 is a top view of the heat shield 3400 of FIGS. 34-36 coupled to the drip tray 2900 of FIGS. 29, 30, and 36. FIG. 38 is a front view of the heat shield 3400 of FIGS. 34-37 coupled to the drip tray 2900 of FIGS. 29, 30, 36, and 37. FIG. 39 is a cross-sectional view of the heat shield 3400 of FIGS. 34-38 coupled to the drip tray 2900 of FIGS. 29, 30, and 36-38, taken along section F-F of FIG. 37. Although the example of FIGS. 36-39 expressly depicts an implementation in which the heat shield 3400 is couplable to and/or is coupled to the drip tray 2900 of FIGS. 29 and 30, it is to be understood that the heat shield 3400 is couplable to and/or can instead be coupled to the drip tray 100 of FIGS. 1-10 in a substantially identical manner.

In the illustrated example of FIGS. 36-39, the heat shield 3400 is couplable to and/or is coupled to the drip tray 2900 via respective ones of the mounting clips 3438 of the heat shield 3400. The heat shield 3400 becomes coupled (e.g., removably coupled) to the drip tray 2900 by inserting the tab 3440 of each one of the mounting clips 3438 into a corresponding one of the peripheral vents 154 formed in the inner wall 150 of the border 104 of the drip tray 2900 (e.g., as shown in FIGS. 37 and 39) such that the heat shield 3400 is clipped (e.g., removably clipped) to the drip tray 2900. When the heat shield 3400 is coupled (e.g., clipped) to the drip tray 2900 via the mounting clips 3438 (e.g., as shown in FIGS. 37-39), the opening 3412 formed in the base 3402 of the heat shield 3400 circumscribes and/or receives the downwardly-projecting lip 114 of the drain 112 formed in the base 102 of the drip tray 2900. The lower portion of the opening 136 of the first central vent 128 formed in the base 102 of the drip tray 2900 circumscribes, receives, and/or is adjacent the upwardly-projecting lip 3424 of the first central vent 3420 formed in the base 3402 of the heat shield 3400 such that the first central vent 3420 formed in the base 3402 of the heat shield 3400 is in fluid communication with the first central vent 128 formed in the base 102 of the drip tray 2900. Similarly, the lower portion of the opening 136 of the second central vent 130 formed in the base 102 of the drip tray 2900 circumscribes, receives, and/or is adjacent the upwardly-projecting lip 3424 of the second central vent 3422 formed in the base 3402 of the heat shield 3400 such that the second central vent 3422 formed in the base 3402 of the heat shield 3400 is in fluid communication with the second central vent 130 formed in the base 102 of the drip tray 2900. The border 3404 of the heat shield 3400 circumscribes the inner wall 150 of the border 104 of the drip tray 2900. The outer wall 152 of the border 104 of the drip tray 2900 circumscribes the border 3404 of the heat shield 3400.

When the heat shield 3400 is coupled (e.g., clipped) to the drip tray 2900 via the mounting clips 3438 (e.g., as shown in FIGS. 37-39), the base 3402 of the heat shield 3400 is located below and is spaced apart from the base 102 of the drip tray 2900. For example, as shown in FIG. 39, the upper surface 3406 of the base 3402 of the heat shield 3400 is located below and is spaced apart from the lower surface 202 of the base 102 of the drip tray 2900, thereby resulting in the formation of an example insulating air gap 3902 therebetween. When the drip tray 2900 and the heat shield 3400 are collectively placed within a cookbox of a grill (e.g., the cookbox 2302 of the grill 2300) over a heat source of the grill (e.g., the heat source 2602 of the grill 2300), the presence of the insulating air gap 3902 between the base 3402 of the heat shield 3400 and the base 102 of the drip tray 2900 (e.g., between the upper surface 3406 of the base 3402 of the heat shield 3400 and the lower surface 202 of the base 102 of the drip tray 2900) advantageously lowers the temperature of the base 102 of the drip tray 2900, thereby enhancing the flow of grease thereon to the drain 112 of the drip tray 2900.

The following paragraphs provide various examples in relation to the disclosed vented drip trays for grills.

Example 1 includes a drip tray for a grill. In Example 1, the drip tray includes a base and a border. The base includes an upper surface, a lower surface, a front edge, a rear edge, a right edge, and a left edge. The border projects upwardly from the upper surface of the base along the front edge, the rear edge, the right edge, and the left edge of the base. The border includes an inner wall, an outer wall, and a plurality of peripheral vents. Respective ones of the peripheral vents are formed in and extend through the inner wall.

Example 2 includes the drip tray of Example 1. In Example 2, the respective ones of the peripheral vents are formed in and extend through the inner wall along two or more of a front portion, a rear portion, a right portion, and a left portion of the border. Respective ones of the front portion, the rear portion, the right portion, and the left portion of the border are adjacent corresponding respective ones of the front edge, the rear edge, the right edge, and the left edge of the base.

Example 3 includes the drip tray of Example 1. In Example 3, the respective ones of the peripheral vents are formed in and extend through the inner wall along each one of a front portion, a rear portion, a right portion, and a left portion of the border. Respective ones of the front portion, the rear portion, the right portion, and the left portion of the border are adjacent corresponding respective ones of the front edge, the rear edge, the right edge, and the left edge of the base.

Example 4 includes the drip tray of Example 1. In Example 4, the inner wall of the border projects upwardly from the upper surface of the base, and the outer wall of the border projects downwardly from the inner wall of the border.

Example 5 includes the drip tray of Example 4. In Example 5, the border has an inverted V-shaped cross-sectional profile formed by the inner wall and the outer wall.

Example 6 includes the drip tray of Example 1. In Example 6, the border forms an upper rim of the drip tray.

Example 7 includes the drip tray of Example 1. In Example 7, the border further includes a plurality of positioning notches formed in the outer wall of the border along two or more of a front portion, a rear portion, a right portion, and a left portion of the border. Respective ones of the front portion, the rear portion, the right portion, and the left portion of the border are adjacent corresponding respective ones of the front edge, the rear edge, the right edge, and the left edge of the base.

Example 8 includes the drip tray of Example 1. In Example 8, the border further includes a plurality of mounting supports extending outwardly from the outer wall of the border along two or more of a front portion, a rear portion, a right portion, and a left portion of the border. Respective ones of the front portion, the rear portion, the right portion, and the left portion of the border are adjacent corresponding respective ones of the front edge, the rear edge, the right edge, and the left edge of the base.

Example 9 includes the drip tray of Example 1. In Example 9, the drip tray further includes a drain formed in the base. The drain includes a lip projecting downwardly from the lower surface of the base. The drain further includes an opening extending through the upper surface and the lower surface of the base. The opening is defined in part by the lip.

Example 10 includes the drip tray of Example 9. In Example 10, the upper surface of the base includes a first portion and a second portion. The first portion is located between the right edge and the drain. The first portion slopes downwardly from the right edge toward the drain. The second portion is located between the left edge and the drain. The second portion slopes downwardly from the left edge toward the drain.

Example 11 includes the drip tray of Example 10. In Example 11, the upper surface of the base further includes a first channel and a second channel. The first channel is located between the first portion and the second portion and further located between the front edge and the drain. The first channel slopes downwardly from the front edge toward the drain. The second channel is located between the first portion and the second portion and further located between the rear edge and the drain. The second channel slopes downwardly from the rear edge toward the drain.

Example 12 includes the drip tray of Example 1. In Example 12, the drip tray further includes a central vent formed in the base. The central vent includes a lip projecting upwardly from the upper surface of the base. The central vent further includes an opening extending through the upper surface and the lower surface of the base. The opening is defined in part by the lip.

Example 13 includes the drip tray of Example 12. In Example 13, the central vent is a first central vent, the lip is a first lip, and the opening is a first opening. In Example 13, the drip tray further includes a second central vent formed in the base and spaced apart from the first central vent. The second central vent includes a second lip projecting upwardly from the upper surface of the base. The second central vent further includes a second opening extending through the upper surface and the lower surface of the base. The second opening is defined in part by the second lip.

Example 14 includes the drip tray of Example 12. In Example 14, the lip includes one or more positioning notches formed in the lip. Respective ones of the one or more positioning notches are configured to receive a mounting bracket of a vent shield. The vent shield has an inverted V-shaped cross-sectional profile. The vent shield is configured to cover the opening of the central vent when the vent shield is mounted on the lip of the central vent with the mounting bracket positioned in the one or more positioning notches.

Example 15 includes the drip tray of Example 12. In Example 15, the central vent includes a first cover segment located at and spanning across an upper edge of the lip, a second cover segment located at and spanning across the upper edge of the lip, and a positioning gap located at the upper edge of the lip between the first cover segment and the second cover segment. The positioning gap is configured to receive a mounting bracket of a vent shield. The vent shield has an inverted V-shaped cross-sectional profile. The vent shield is configured to cover at least a portion of the first cover segment and at least a portion of the second cover segment when the vent shield is mounted on the lip of the central vent with the mounting bracket positioned in the positioning gap.

Example 16 is a grill. In Example 16, the grill includes a cookbox, a cooking grate, a heat source, and a drip tray. The cooking grate is positioned within the cookbox. The heat source is positioned within the cookbox below the cooking grate. The drip tray is positioned within the cookbox below the cooking grate and above the heat source. The drip tray includes a base and a border. The base includes an upper surface, a lower surface, a front edge, a rear edge, a right edge, and a left edge. The border projects upwardly from the upper surface of the base along the front edge, the rear edge, the right edge, and the left edge of the base. The border includes an inner wall, an outer wall, and a plurality of peripheral vents. Respective ones of the peripheral vents are formed in and extend through the inner wall.

Example 17 includes the grill of Example 16. In Example 17, the inner wall of the border projects upwardly from the upper surface of the base. The outer wall of the border projects downwardly from the inner wall of the border. The border has an inverted V-shaped cross-sectional profile formed by the inner wall and the outer wall.

Example 18 includes the grill of Example 16. In Example 18, the drip tray further includes a drain formed in the base. The drain includes a lip projecting downwardly from the lower surface of the base. The drain further includes an opening extending through the upper surface and the lower surface of the base. The opening is defined in part by the lip. In Example 18, the grill further includes a waste bin and a waste chute. The waste bin is slidably coupled to the cookbox. The waste bin is positioned below an opening formed in and extending through a bottom wall of the cookbox. The waste chute is positioned between the drip tray and the waste bin. The waste chute is configured to transport waste from the opening of the drain of the drip tray downwardly into the waste bin.

Example 19 includes the grill of Example 16. In Example 19, the drip tray further includes a central vent formed in the base. The central vent includes a lip projecting upwardly from the upper surface of the base. The central vent further includes an opening extending through the upper surface and the lower surface of the base. The opening is defined in part by the lip. In Example 19, the grill further includes a vent shield mounted on the lip of the central vent. The vent shield has an inverted V-shaped cross-sectional profile. The vent shield covers the opening of the central vent.

Example 20 includes the grill of Example 16. In example 20, the grill further includes a heat shield positioned within the cookbox below the drip tray and above the heat source. The heat shield includes a plurality of clips. Respective ones of the plurality of clips are configured to extend into corresponding respective ones of the plurality of peripheral vents to couple the heat shield to the drip tray.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A grill, comprising:
a cookbox including a bottom wall and an opening formed in and extending through the bottom wall of the cookbox;
a cooking grate positioned within the cookbox;
a heat source positioned within the cookbox below the cooking grate;
a drip tray positioned within the cookbox below the cooking grate and above the heat source, the drip tray including a base, a border, and a drain, the drain including an opening formed in and extending through the base;
a waste bin slidably coupled to the cookbox, the waste bin positioned below the opening of the bottom wall of the cookbox; and
a waste chute positioned within the cookbox, the waste chute configured to receive waste from the opening of the drain of the drip tray and direct the received waste to pass through the opening of the bottom wall of the cookbox and into the waste bin.

2. The grill of claim 1, wherein the waste chute includes an open upper end that faces upwardly toward the base of the drip tray and an open lower end that faces downwardly toward the waste bin.

3. The grill of claim 2, wherein the open lower end of the waste chute extends to or through the opening of the bottom wall of the cookbox.

4. The grill of claim 3, wherein the drain includes a lip projecting downwardly from the base, the opening of the drain defined in part by the lip of the drain, wherein the open upper end of the waste chute circumscribes the lip of the drain, and the open lower end of the waste chute is circumscribed by the opening of the bottom wall of the cookbox and by a periphery of an upper rim of the waste bin.

5. The grill of claim 4, wherein the waste chute provides a closed pathway between the drip tray and the waste bin.

6. The grill of claim 1, wherein the base of the drip tray includes an upper surface, a lower surface, a front edge, a rear edge, a right edge, and a left edge, and wherein the border of the drip tray projects upwardly from the upper surface of the base along the front edge, the rear edge, the right edge, and the left edge of the base, the border including an inner wall, an outer wall, and a plurality of peripheral vents, wherein respective ones of the peripheral vents are formed in and extend through the inner wall.

7. The grill of claim 6, wherein the respective ones of the peripheral vents are formed in and extend through the inner wall along two or more of a front portion, a rear portion, a right portion, and a left portion of the border, wherein respective ones of the front portion, the rear portion, the right portion, and the left portion of the border are adjacent corresponding respective ones of the front edge, the rear edge, the right edge, and the left edge of the base.

8. The grill of claim 6, wherein the respective ones of the peripheral vents are formed in and extend through the inner wall along each one of a front portion, a rear portion, a right portion, and a left portion of the border, wherein respective ones of the front portion, the rear portion, the right portion, and the left portion of the border are adjacent corresponding respective ones of the front edge, the rear edge, the right edge, and the left edge of the base.

9. The grill of claim 6, wherein the inner wall of the border projects upwardly from the upper surface of the base, and wherein the outer wall of the border projects downwardly from the inner wall of the border.

10. The grill of claim 9, wherein the border has an inverted V-shaped cross-sectional profile formed by the inner wall and the outer wall.

11. The grill of claim 6, wherein the border forms an upper rim of the drip tray.

12. The grill of claim 6, wherein the border further includes a plurality of positioning notches formed in the outer wall of the border along two or more of a front portion, a rear portion, a right portion, and a left portion of the border, wherein respective ones of the front portion, the rear portion, the right portion, and the left portion of the border are adjacent corresponding respective ones of the front edge, the rear edge, the right edge, and the left edge of the base.

13. The grill of claim 6, wherein the border further includes a plurality of mounting supports extending outwardly from the outer wall of the border along two or more of a front portion, a rear portion, a right portion, and a left portion of the border, wherein respective ones of the front portion, the rear portion, the right portion, and the left portion of the border are adjacent corresponding respective ones of the front edge, the rear edge, the right edge, and the left edge of the base.

14. The grill of claim 6, wherein the upper surface of the base includes a first portion and a second portion, the first portion located between the right edge and the drain, the first portion sloping downwardly from the right edge toward the drain, the second portion located between the left edge and the drain, the second portion sloping downwardly from the left edge toward the drain.

15. The grill of claim 14, wherein the upper surface of the base further includes a first channel and a second channel, the first channel located between the first portion and the second portion and further located between the front edge and the drain, the first channel sloping downwardly from the front edge toward the drain, the second channel located between the first portion and the second portion and further located between the rear edge and the drain, the second channel sloping downwardly from the rear edge toward the drain.

16. The grill of claim 6, further comprising a central vent formed in the base, the central vent including a lip projecting upwardly from the upper surface of the base, the central vent further including an opening formed in and extending through the upper surface and the lower surface of the base, wherein the opening of the central vent is defined in part by the lip of the central vent.

17. The grill of claim 16, wherein the central vent is a first central vent, the lip of the central vent is a first lip of the first central vent, and the opening of the central vent is a first opening of the first central vent, the drip tray further comprising a second central vent formed in the base and spaced apart from the first central vent, the second central vent including a second lip projecting upwardly from the upper surface of the base, the second central vent further including a second opening formed in and extending through the upper surface and the lower surface of the base, wherein the second opening of the second central vent is defined in part by the second lip of the second central vent.

18. The grill of claim 16, wherein the lip of the central vent includes one or more positioning notches formed in the lip of the central vent, wherein respective ones of the one or more positioning notches are configured to receive a mounting bracket of a vent shield, wherein the vent shield has an inverted V-shaped cross-sectional profile, and wherein the vent shield is configured to cover the opening of the central vent when the vent shield is mounted on the lip of the central vent with the mounting bracket positioned in the one or more positioning notches.

19. The grill of claim 16, wherein the central vent includes a first cover segment located at and spanning across an upper edge of the lip of the central vent, a second cover segment located at and spanning across the upper edge of the lip of the central vent, and a positioning gap located at the upper edge of the lip of the central vent between the first cover segment and the second cover segment, wherein the positioning gap is configured to receive a mounting bracket of a vent shield, wherein the vent shield has an inverted V-shaped cross-sectional profile, and wherein the vent shield is configured to cover at least a portion of the first cover segment and at least a portion of the second cover segment when the vent shield is mounted on the lip of the central vent with the mounting bracket positioned in the positioning gap.

20. The grill of claim 6, further comprising a heat shield positioned within the cookbox below the drip tray and above the heat source, the heat shield including a plurality of clips, wherein respective ones of the plurality of clips are configured to extend into corresponding respective ones of the plurality of peripheral vents to couple the heat shield to the drip tray.
